(19) United States
(12) Patent Application Publication
(10) Pub. No.: US 2025/0371744 A1
(43) Pub. Date: Dec. 4, 2025

(54) ENCODING METHOD, DECODING METHOD, ENCODING DEVICE, AND DECODING DEVICE

(71) Applicant: Panasonic Intellectual Property Corporation of America, Torrance, CA (US)

(72) Inventors: Atsushi ITO, Osaka (JP); Toshiyasu SUGIO, Osaka (JP); Noritaka IGUCHI, Osaka (JP); Takahiro NISHI, Nara (JP)

(21) Appl. No.: 19/299,527

(22) Filed: Aug. 14, 2025

Related U.S. Application Data
(63) Continuation of application No. PCT/JP2024/005179, filed on Feb. 15, 2024.
(60) Provisional application No. 63/447,443, filed on Feb. 22, 2023.
(60) Provisional application No. 63/452,750, filed on Mar. 17, 2023.

(51) Int. Cl. G06T 9/40

(52) U.S. Cl. CPC G06T 9/40

(57) ABSTRACT

An encoding method for encoding three-dimensional points includes: determining whether four first edge vertices are generated on four first edges of a first surface of a first node, respectively; and encoding the three-dimensional points, based on a result of the determining. The four first edge vertices are to be used in a TriSoup scheme, and the first node is a unit for containing three-dimensional points included in an octree structure.

### CROSS REFERENCE TO RELATED APPLICATIONS

This application is a U.S. continuation application of PCT International Patent Application Number PCT/JP2024/005179 filed on Feb. 15, 2024, claiming the benefit of priority of U.S. Provisional Patent Application No. 63/447,443 filed on Feb. 22, 2023 and U.S. Provisional Patent Application No. 63/452,750 filed on Mar. 17, 2023, the entire contents of which are hereby incorporated by reference.

### FIELD

The present disclosure relates to an encoding method, a decoding method, an encoding device, and a decoding device.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

Furthermore, as an encoding scheme, there are cases where an irreversible compression scheme is used. In such a case, the decoded point cloud does not perfectly match the original point cloud. Therefore, there is a demand for improving the reproducibility of a point cloud to be decoded.

The present disclosure provides an encoding method, a decoding method, an encoding device, or a decoding device that is capable of improving reproducibility of a point cloud to be decoded.

### Solution to Problem

An encoding method according to an aspect of the present disclosure is an encoding method for encoding three-dimensional points. The encoding method includes: determining whether four first edge vertices are generated on four first edges of a first surface of a first node, respectively; and encoding the three-dimensional points, based on a result of the determining. The four first edge vertices are to be used in a TriSoup scheme, and the first node is a unit for containing three-dimensional points included in an octree structure.

A decoding method according to an aspect of the present disclosure is a decoding method for decoding encoded three-dimensional points. The decoding method includes: decoding encoded first edge vertices in a first node to generate first edge vertices on first edges of the first node, the first edges being parallel to each other; and estimating one or two positions of one or two second edge vertices on one or two second edges, using positions of the first edge vertices, when a total number of the first edge vertices is less than four, the one or two second edges being other than and parallel to the first edges. The first edge vertices and the one or two second edge vertices are to be used in a TriSoup scheme, and the first node is a unit for containing three-dimensional points included in an octree structure.

A decoding method according to an aspect of the present disclosure is a decoding method for decoding encoded three-dimensional points. The decoding method includes: determining whether a first surface of a first node is parallel to a cross section of the first node; and decoding the encoded three-dimensional points, based on a result of the determining. The first surface includes four edges on which four edge vertices are provided, respectively. The cross section passes through a first centroid vertex of the first node. The cross section is defined by two pairs of face vertices. The two pairs of face vertices are provided on second surfaces perpendicular to the first surface. A line connecting the first centroid vertex and a second centroid vertex of a second node adjacent to the first node intersects a face vertex included in the two pairs of face vertices. The first centroid vertex, the second centroid vertex, and the four edge vertices are to be used in a TriSoup scheme. The first node is a unit for containing three-dimensional points included in an octree structure.

### Advantageous Effects

The present disclosure can provide an encoding method, a decoding method, an encoding device, or a decoding device that is capable of improving reproducibility of a point cloud to be decoded.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an original point cloud according to Embodiment 1.

FIG. 2 is a diagram illustrating an example of a trimmed octree according to Embodiment 1.

FIG. 3 is a diagram illustrating an example in which a leaf-node according to Embodiment 1 is two-dimensionally displayed.

FIG. 4 is a diagram for describing a method for generating a centroid vertex according to Embodiment 1.

FIG. 5 is a diagram for describing the method for generating a centroid vertex according to Embodiment 1.

FIG. 6 is a diagram illustrating an example of vertex information according to Embodiment 1

FIG. 7 is a diagram illustrating an example of a TriSoup surface according to Embodiment 1.

FIG. 8 is a diagram for describing point cloud reconstruction processing according to Embodiment 1.

FIG. 9 is a diagram illustrating an example of a point cloud according to Embodiment 1.

FIG. 10 is a diagram illustrating an example of centroid vertex generation according to Embodiment 1.

FIG. 11 is a diagram illustrating an example of triangle (TriSoup surface) generation according to Embodiment 1.

FIG. 12 is a diagram illustrating an example of face vertex generation according to Embodiment 1.

FIG. 13 is a diagram illustrating an example of generation of edge vertices and centroid vertices according to Embodiment 1.

FIG. 14 is a diagram for describing an adjusting method of edge vertices according to Embodiment 1.

FIG. 15 is a diagram for describing another adjusting method of edge vertices according to Embodiment 1.

FIG. 16 is a diagram illustrating an example of a plurality of vertices according to Embodiment 1.

FIG. 17 is a diagram illustrating an example of vertices generated in four nodes according to Embodiment 1.

FIG. 18 is a diagram illustrating an example of vertices generated in four nodes according to Embodiment 1.

FIG. 19 is a diagram illustrating an example of vertices generated in four nodes according to Embodiment 1.

FIG. 20 is a diagram illustrating a dependency relationship of information in reconstruction of vertex coordinates according to Embodiment 1.

FIG. 21 is a diagram illustrating an example of vertices generated in four nodes according to Embodiment 1.

FIG. 22 is a flowchart of decoding processing according to Embodiment 1.

FIG. 23 is a flowchart of generation processing of a plurality of triangles according to Embodiment 1.

FIG. 24 is a diagram illustrating an example of edge vertex and centroid vertex generation according to Embodiment 2.

FIG. 25 is a diagram illustrating an example of a surface to be reconstructed according to Embodiment 2.

FIG. 26 is a diagram illustrating an example of centroid vertex and edge vertex generation according to Embodiment 2.

FIG. 27 is a diagram illustrating an example of a surface to be reconstructed according to Embodiment 2.

FIG. 28 is a diagram illustrating an example of centroid vertex, edge vertex, and face vertex generation according to Embodiment 2.

FIG. 29 is a diagram illustrating an example of centroid vertex, edge vertex, and face vertex generation according to Embodiment 2.

FIG. 30 is a flowchart of encoding processing according to Embodiment 2.

FIG. 31 is a flowchart of edge vertex re-generation processing according to Embodiment 2.

FIG. 32 is a flowchart of encoding processing and decoding processing according to Embodiment 2.

FIG. 33 is a flowchart of edge vertex adding processing according to Embodiment 2.

FIG. 34 is a flowchart of decoding processing according to an embodiment.

FIG. 35 is a block diagram of a decoding device according to the embodiment.

FIG. 36 is a flowchart of encoding processing according to the embodiment.

FIG. 37 is a block diagram of an encoding device according to the embodiment.

### DESCRIPTION OF EMBODIMENTS

An encoding method according to an aspect of the present disclosure is an encoding method for encoding three-dimensional points. The encoding method includes: determining whether four first edge vertices are generated on four first edges of a first surface of a first node, respectively; and encoding the three-dimensional points, based on a result of the determining. The four first edge vertices are to be used in a TriSoup scheme, and the first node is a unit for containing three-dimensional points included in an octree structure.

Accordingly, the encoding method can, for example, determine whether a first edge vertex is correctly generated, based on whether the four first edge vertices are generated on the four first edges of the first surface, respectively. Specifically, when first edge vertices are generated on all of the first edges, there is a possibility that an edge vertex for reconstructing an original point cloud is not correctly generated. Accordingly, the encoding method can, for example, improve reproducibility of the point cloud to be decoded by a decoding device, by performing encoding processing that is in accordance with the result of the determining. Encoding processing that is in accordance with the result of the determining refers to, for example, correcting an edge position or not generating an edge vertex to be described later.

For example, the encoding method may further include: performing at least one of a first process or a second process, when the four first edge vertices are generated on the four first edges, respectively. In the first process, second edge vertices may each be generated on a different one of second edges of the first node, the second edges orthogonally intersecting the first surface, and, in the second process, a threshold for generating an edge vertex may be increased, the threshold being a threshold to be compared to distances between three dimensional points and an edge.

Accordingly, when an edge vertex is not correctly generated, the encoding method can generate the correct edge vertex by generating an additional edge vertex or re-generating an edge vertex. Accordingly, reproducibility of the point cloud to be decoded by a decoding device can be improved.

For example, in the second process, the threshold for the second edges may be increased. Accordingly, when an edge vertex is erroneously generated on the first surface and an edge vertex is not generated on some of the second edges, the encoding method can generate the correct edge vertices.

For example, in the second process, the threshold may be repeatedly increased until the second edge vertices are generated. Accordingly, the encoding method can generate the appropriate edge vertex by gradually increasing the threshold.

For example, in the first process, when a total number of the second edge vertices is less than four, one or two positions of one or two edge vertices may be estimated using positions of the second edge vertices. Accordingly, the encoding method can generate the edge vertex to be added, by using the second edge vertices.

For example, in the first process, when the total number is less than four, attribute information of the one or two edge vertices may be estimated from attribute information of the second edge vertices. Accordingly, the encoding method can improve reproducibility of the point cloud to be decoded, by estimating the attribute information of the second edge vertices.

A decoding method according to an aspect of the present disclosure is a decoding method for decoding encoded three-dimensional points. The decoding method includes: decoding encoded first edge vertices in a first node to generate first edge vertices on first edges of the first node, the first edges being parallel to each other; and estimating one or two positions of one or two second edge vertices on one or two second edges, using positions of the first edge vertices, when a total number of the first edge vertices is less than four, the one or two second edges being other than and parallel to the first edges. The first edge vertices and the one or two second edge vertices are to be used in a TriSoup scheme, and the first node is a unit for containing three-dimensional points included in an octree structure.

Accordingly, when an edge vertex is not correctly generated, the decoding method can additionally generate a second edge vertex. Accordingly, the decoding method can improve reproducibility of the point cloud to be decoded.

For example, the estimating may be performed according to control information included in a bitstream and indicating whether to perform the estimating. Accordingly, the decoding method can determine whether to perform estimating, based on the control information generated by an encoding device, and thus the determining by a decoding device can be simplified, and the processing amount of the decoding device can be reduced.

For example, in the estimating, attribute information of the one or two second edge vertices may be estimated from attribute information of the first edge vertices. Accordingly, the decoding method can improve reproducibility of the point cloud to be reduced, by estimating the attribute information of the second edge vertex.

A decoding method according to an aspect of the present disclosure is a decoding method for decoding encoded three-dimensional points. The decoding method includes: determining whether a first surface of a first node is parallel to a cross section of the first node; and decoding the encoded three-dimensional points, based on a result of the determining. The first surface includes four edges on which four edge vertices are provided, respectively. The cross section passes through a first centroid vertex of the first node. The cross section is defined by two pairs of face vertices. The two pairs of face vertices are provided on second surfaces perpendicular to the first surface. A line connecting the first centroid vertex and a second centroid vertex of a second node adjacent to the first node intersects a face vertex included in the two pairs of face vertices. The first centroid vertex, the second centroid vertex, and the four edge vertices are to be used in a TriSoup scheme. The first node is a unit for containing three-dimensional points included in an octree structure.

Accordingly, the decoding method can, for example, determine whether a vertex is generated correctly, based on whether the first surface is parallel to the cross section of the first node, for example. Accordingly, the decoding method can improve reproducibility of the point cloud to be decoded, by performing decoding processing that is in accordance with the result of the determining, for example.

For example, in the decoding, when the first surface is determined not to be parallel to the cross section, the encoded three-dimensional points may be decoded according to the TriSoup scheme to locate three-dimensional points on an approximate surface defined by the first centroid vertex and the four edge vertices. Accordingly, for example, when the first surface is not parallel to the cross section of the first node, the decoding method determines that the edge vertex is correctly generated, and generates an approximate surface using the edge vertex, thereby improving reproducibility of the point cloud to be decoded.

For example, in the decoding, when the first surface is determined to be parallel to the cross section, the encoded three-dimensional points may be decoded to locate three-dimensional points on the cross section. Accordingly, for example, when the first surface is parallel to the cross section of the first node, the decoding method determines that the edge vertex is not correctly generated, and generates three-dimensional points in a cross section defined by a centroid vertex and a face vertex. Accordingly, reproducibility of the point cloud to be decoded can be improved.

Furthermore, an encoding device according to an aspect of the present disclosure is an encoding device that encodes three-dimensional points. The encoding device includes: a processor; and memory. Using the memory, the processor: determines whether four first edge vertices are generated on four first edges of a first surface of a first node, respectively; and encodes the three-dimensional points, based on a result of the determining. The four first edge vertices are to be used in a TriSoup scheme, and the first node is a unit for containing three-dimensional points included in an octree structure.

A decoding device according to an aspect of the present disclosure is a decoding device that decodes encoded three-dimensional points. The decoding device includes: a processor; and memory. Using the memory, the processor: decodes encoded first edge vertices in a first node to generate first edge vertices on first edges of the first node, the first edges being parallel to each other; and estimates one or two positions of one or two second edge vertices on one or two second edges, using positions of the first edge vertices, when a total number of the first edge vertices is less than four, the one or two second edges being other than and parallel to the first edges. The first edge vertices and the one or two second edge vertices are to be used in a TriSoup scheme, and the first node is a unit for containing three-dimensional points included in an octree structure.

A decoding device according to an aspect of the present disclosure is a decoding device that decodes encoded three-dimensional points. The decoding device includes: a processor; and memory. Using the memory, the processor: determines whether a first surface of a first node is parallel to a cross section of the first node; and decodes the encoded three-dimensional points, based on a result of the determining. The first surface includes four edges on which four edge vertices are provided, respectively. The cross section passes through a first centroid vertex of the first node. The cross section is defined by two pairs of face vertices. The two pairs of face vertices are provided on second surfaces perpendicular to the first surface. A line connecting the first centroid vertex and a second centroid vertex of a second node adjacent to the first node intersects a face vertex included in the two pairs of face vertices. The first centroid vertex, the second centroid vertex, and the four edge vertices are to be used in a TriSoup scheme. The first node is a unit for containing three-dimensional points included in an octree structure.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment 1

Hereinafter, an encoding device (three-dimensional data encoding device) and a decoding device (three-dimensional data decoding device) according to the present embodiment will be described. The encoding device encodes three-dimensional data to thereby generate a bitstream. The decoding device decodes the bitstream to thereby generate three-dimensional data.

Three-dimensional data is, for example, three-dimensional point cloud data (also called point cloud data). A point cloud, which points, represents the is a set of three-dimensional three-dimensional shape of an object. The point cloud data includes position information and attribute on information the three-dimensional points. The position information indicates the three-dimensional position of each three-dimensional point. It should be noted that position information may also be called geometry information. For example, the position information is represented using an orthogonal coordinate system or a polar coordinate system.

Attribute information indicates color information, reflectance, infrared information, a normal vector, or time-of-day information, for example. One three-dimensional point may have a single item of attribute information or have a plurality of kinds of attribute information.

It should be noted that although mainly the encoding and decoding of position information will be described below, the encoding device may perform encoding and decoding of attribute information.

### [TriSoup Scheme]

The encoding device according to the present embodiment encodes position information by using a Triangle-Soup (TriSoup) scheme.

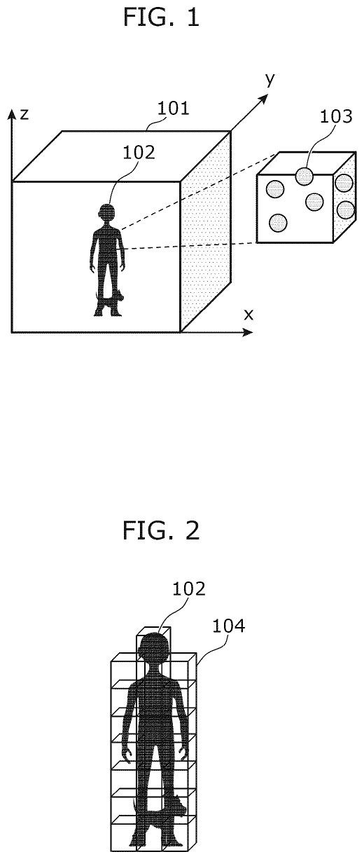

The TriSoup scheme is an irreversible compression scheme for encoding position information on point cloud data. In the TriSoup scheme, an original point cloud being processed is replaced by a set of triangles, and the point cloud is approximated on the planes of the triangles. Specifically, the original point cloud is replaced by vertex information on vertexes (hereinafter also referred to as vertices) within each node, and the vertexes are connected with each other to form a group of triangles. Furthermore, the vertex information for generating the triangles is stored in a bitstream, which is sent to the Now, encoding processing using the TriSoup scheme will be described. FIG. 1 is a diagram illustrating an example of an original point cloud. As shown in FIG. 1, point cloud 102 of an object is in target space 101 and includes points 103.

First, the encoding device divides the original point cloud into an octree up to a predetermined depth. In octree division, a target space is divided into eight nodes (subspaces), and 8-bit information (an occupancy code) indicating whether each node includes a point cloud is generated. A node that includes a point cloud is further divided into eight nodes, and 8-bit information indicating whether these eight nodes each include a point cloud is generated. This processing is repeated up to a predetermined layer.

Here, typical octree encoding divides nodes until the number of point clouds in each node reaches, for example, one or a threshold. In contrast, the TriSoup scheme performs octree division up to a layer along the way and not for layers lower than that layer. Such an octree up to a midway layer is called a trimmed octree.

FIG. 2 is a diagram illustrating an example of a trimmed octree. As shown in FIG. 2, point cloud 102 is divided into leaf-nodes 104 (lowest-layer nodes) of a trimmed octree.

The encoding device then performs the following processing for each leaf-node 104 of the trimmed octree. It should be noted that a leaf-node may hereinafter also be simply referred to as a node. The encoding device generates vertexes on edges of the node as representative points of the point cloud near the edges. These vertexes are called edge vertexes. For example, an edge vertex is generated on each of a plurality of edges (for example, four parallel edges).

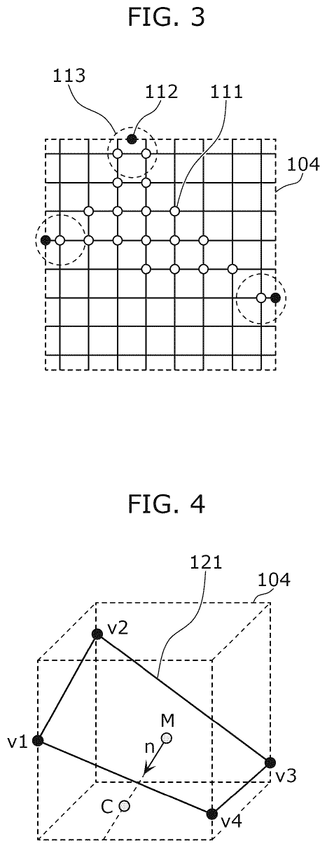

FIG. 3 is a diagram illustrating an example of two-dimensional display of leaf-node 104, for example, the xy-plane viewed along the z-direction shown in FIG. 1. As shown in FIG. 3, edge vertexes 112 are generated on edges based on points near the edges, among points 111 within leaf-node 104.

It should be noted that the dotted lines in FIG. 3 along the perimeter of leaf-node 104 represent the edges. Also in this example, each edge vertex 112 is generated at a weighted average of the positions of points within the distance 1 from the corresponding edge (points within each range 113 in FIG. 3). It should be noted that the unit of distance may be, by way of example and not limitation, the resolution of the point cloud. Although the distance (the threshold) is 1 in this example, the distance may be a value other than 1 or may be variable.

The encoding device then generates a vertex inside the node as well, based on a point cloud located in the direction of the normal to the plane that includes edge vertexes. This vertex is called a centroid vertex.

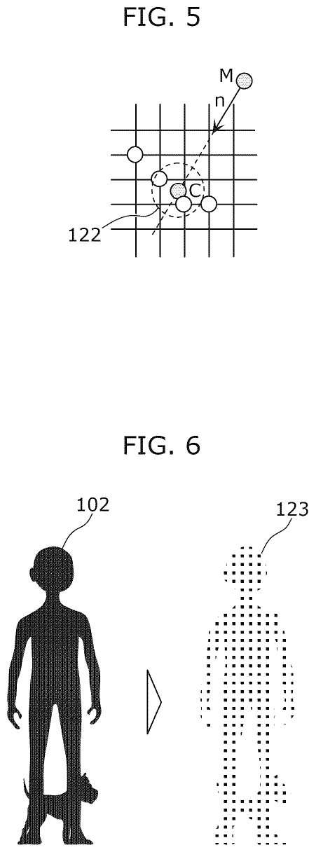

FIGS. 4 and 5 are diagrams for describing a method for generating the centroid vertex. First, the encoding device selects, for example, four points as representative points from a group of edge vertexes. In the example shown in FIG. 4, edge vertexes v1 to v4 are selected. The encoding device then calculates approximate surface 121 passing through the four points. The encoding device then calculates normal n to approximate surface 121 and average coordinates M of the four points. The encoding device then generates centroid vertex C at weighted-average coordinates of one or more points near a half line extending along normal n from average coordinates M (e.g., points within range 122 shown in FIG. 5).

The encoding device then entropy-encodes vertex information, which is information on the edge vertexes and the centroid vertex, and stores the encoded vertex information in a geometry data unit (hereinafter referred to as a GDU) included in the bitstream. It should be noted that, in addition to the vertex information, the GDU includes information indicating the trimmed octree.

FIG. 6 is a diagram illustrating an example of the vertex information. The above processing transforms point cloud 102 into vertex information 123, as shown in FIG. 6.

Now, decoding processing for the bitstream generated as above will be described. First, the decoding device decodes the GDU from the bitstream to obtain the vertex information. The decoding device then connects the vertexes to generate a TriSoup surface, which is a group of triangles.

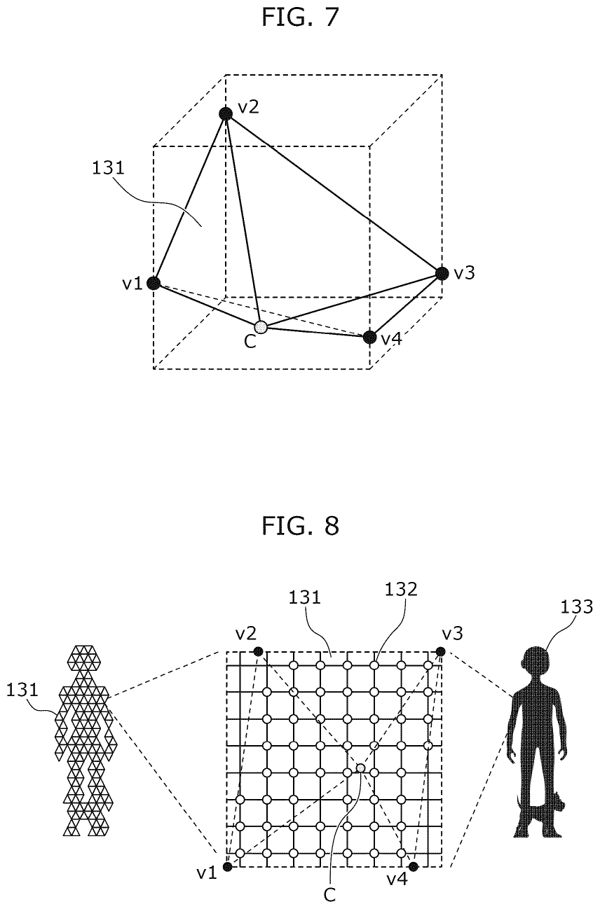

FIG. 7 is a diagram illustrating an example of the TriSoup surface. In the example shown in FIG. 7, four edge vertexes v1 to v4 and centroid vertex C are generated based on the vertex information. Furthermore, triangles 131 (a TriSoup surface) are generated, each having centroid vertex C and two edge vertexes as its vertexes. For example, a pair of two edge vertexes on a pair of two neighboring edges is selected to form triangle 131 having the selected pair of edge vertexes and the centroid vertex as its vertexes.

FIG. 8 is a diagram for describing point cloud reconstruction processing. The above processing is performed for each leaf-node to generate a three-dimensional model that represents the object with triangles 131, as shown in FIG. 8.

The decoding device then generates points 132 at regular intervals on the surface of triangles 131 to reconstruct the position information on point cloud 133.

### [Example of Representation of Ridge Line of Point Cloud Surface]

According to the TriSoup scheme, the shape of the ridge line (ridge) across the neighboring nodes cannot be reconstructed in some cases. In contrast, the encoding device generates the face vertex on the surface in contact with the neighboring node, and reconstructs the point cloud also on the surface of the triangle generated based on the centroid vertex, the face vertices, and the edge vertices.

For example, in a case where a bent portion of the point cloud distribution (point cloud surface) is distributed within the leaf node, the surface model made by connecting the vertices cannot reproduce the shape of the original point cloud in some cases because the corner of the point cloud surface and the edge do not intersect each other and no vertex is formed at the position of the corner.

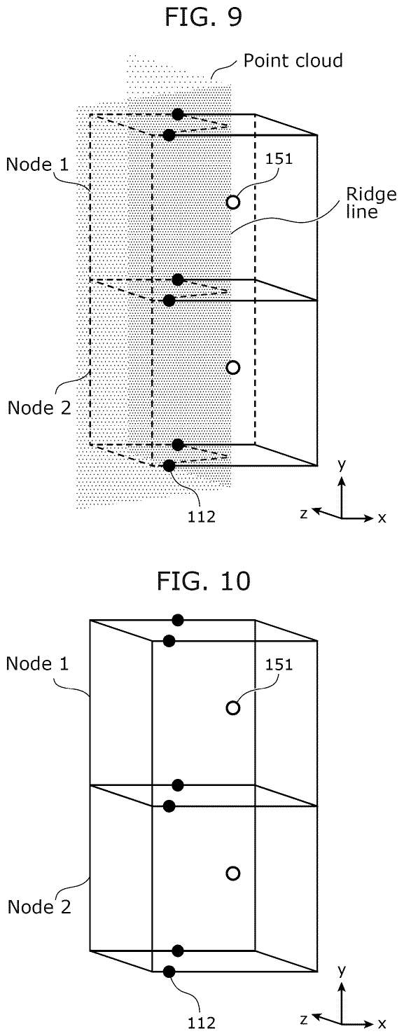

FIG. 9 is a diagram illustrating an example of a point cloud in a case where a point cloud is distributed across node 1 and node 2, and a ridge line is formed. As shown in FIG. 9, based on the point cloud distribution close to edges, edge vertices 112 are generated.

FIG. 10 is a diagram illustrating a centroid vertex generation example in this case. As shown in FIG. 10, each centroid vertex 151 is formed in the normal direction of an approximate surface of the edge vertex group.

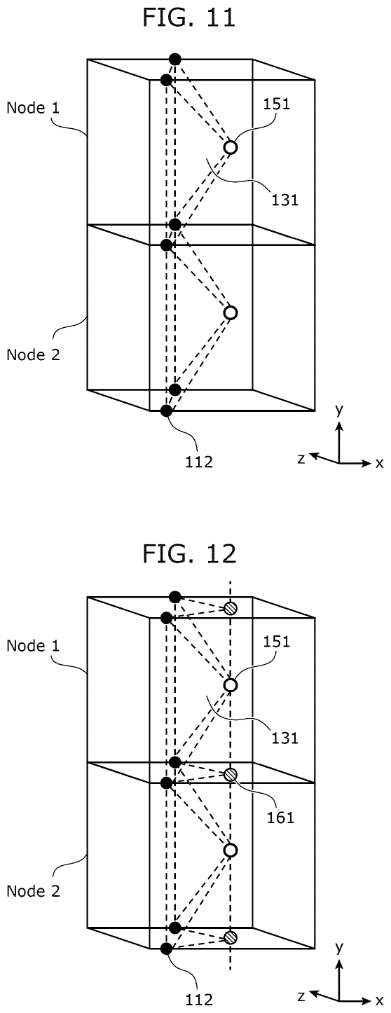

FIG. 11 is a diagram illustrating a generation example of triangles 131 (TriSoup surface) in this case. As shown in FIG. 11, each triangle 131 is generated by connecting a plurality of vertices (plurality of edge vertices and a centroid vertex). In this case, as illustrated in FIG. 11, the point cloud in the vicinity of the node boundary cannot be reproduced.

This is because the centroid vertex successfully samples the original point cloud surface but the current scheme can create no vertex between two centroid vertices of two neighboring nodes. For example, in a case where a ridge line is continuously distributed in the node along the direction of any of x, y, and z axes, no vertex corresponding to the ridge line is formed because the ridge line is not across any edge. Accordingly, this problem occurs.

In the present embodiment, the encoding device predicts the ridge line of the point cloud surface. Upon determination that two neighboring nodes have the same ridge line, this device transfers, to the decoding device, information for connecting two centroid vertices of the two neighboring nodes by a line segment. This information is, for example, 1-bit information assigned to each surface between nodes.

The decoding device connects the centroid vertices using this information, and generates a new vertex (face vertex) at an intersection between the obtained line segment and a shared surface between the nodes. When generating triangle 131, the decoding device can reproduce the ridge line using the new vertex.

Since the coordinate position of the face vertex is not quantized, a problem of positional deviation due to quantization is not present.

FIG. 12 is a diagram illustrating an example of generation of a face vertex. As illustrated in FIG. 12, the decoding device can reproduce a ridge line by generating face vertex 161, and generating triangle 131 by using face vertex 161.

With the above-described technique, since a point-cloud surface in the vicinity a node boundary can be reproduced, a decoded point cloud closer to an original point cloud can be obtained. It should be noted that, in the above-described description, since the point-cloud surface is merely used for describing a problem related to a ridge line, and the ridge line need not be actually obtained.

### [Problem of Flat Surface Reconstruction]

When reconstructing a point cloud including a flat surface by using these various vertices, there is a possibility that the surface of the reconstructed point cloud does not form a flat surface, and unevenness that does not exist in the original point cloud occurs. Probable causes are as follows. It should be noted that this problem occurs irrespective of whether or not a surface that spans a neighboring node is used by using a face vertex. For example, when the accuracy of an edge vertex is lower than the accuracy of a centroid vertex, a difference is generated in the position of each vertex that is created for a surface of a point cloud that crosses a node in a planar manner.

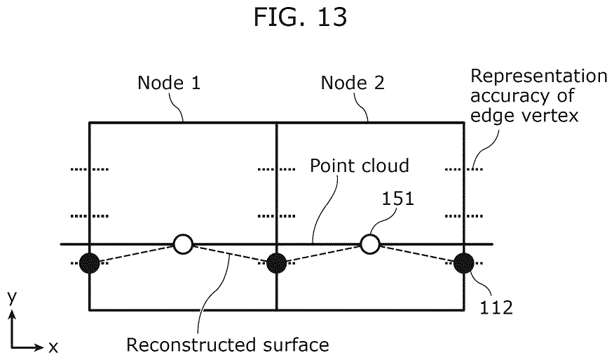

FIG. 13 is a diagram illustrating an example of generation of edge vertices and centroid vertices in this case. FIG. 13 illustrates node 1 and node 2 that are arranged in an x direction. For example, the accuracy of edge vertex 112 is ¼ of the representation capability (the 8th position) of the edge length when the node width is 32. On the other hand, centroid vertices 151 have the accuracy of integer coordinates.

As illustrated in FIG. 13, this reconstructed surface obtained from vertices with differences in the height positions (y coordinate) has a waved shape, and does not become a flat surface as in the original point cloud. It should be noted that a surface is formed from, for example, a plurality of triangles generated based on a group of vertices in one or more nodes.

As a solution to this problem, although it is also conceivable to improve the accuracy of position of an edge vertex, there is a problem that when the accuracy is uniformly improved, the data amount of the edge vertex in a region for which improvement in accuracy is not required is also uniformly increased. In addition, there is a problem that when variable bit allocation that changes the number of bits of data for each edge vertex is used, processing becomes complicated. Thus, neither method is practical.

### Solution

In the present embodiment, the decoding device adjusts the position of an edge vertex, when it can be estimated that a point cloud in a node has been a flat surface by using the positional relationship between a centroid vertex and a face vertex. Accordingly, a surface to be reconstructed can be formed into a flat surface.

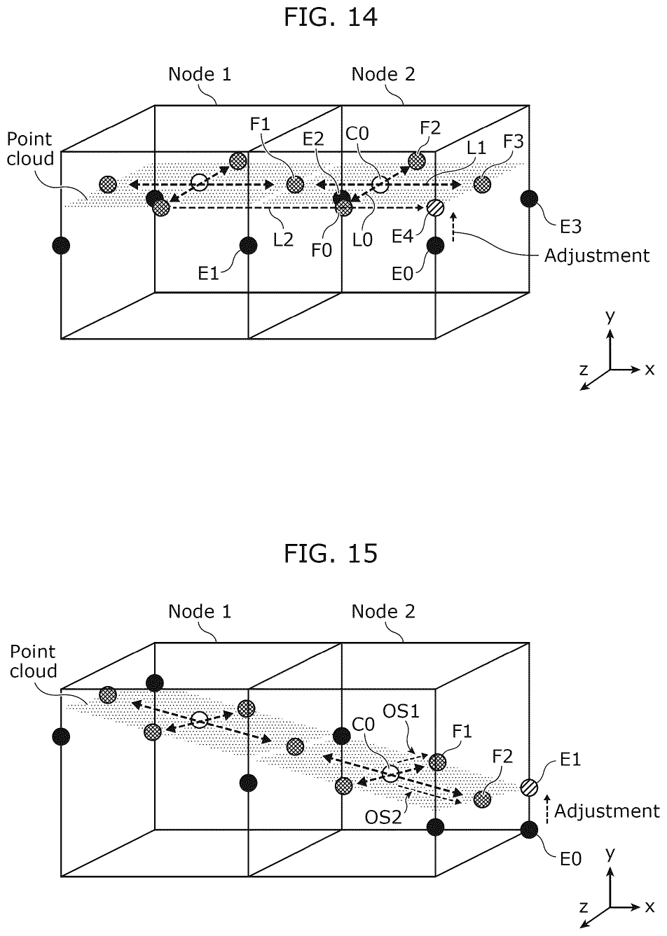

FIG. 14 is a diagram for describing this adjusting method of edge vertices. FIG. 14 illustrates node 1 and node 2 that are arranged in the x direction. In addition, node 2 is a current node to be processed. Node 2 includes centroid vertex C0, edge vertices E0, E1, E2, and E3, and face vertices F0, F1, F2, and F3.

It should be noted that, for example, only one centroid vertex is generated for one node. At most one edge vertex is generated per edge (that is, only one is generated, or not generated). At most one face vertex is generated per face.

First, before the processing of reconstructing a surface by using a plurality of vertices in a current node, the decoding device determines whether a pair of face vertices (for example, F0 and F2) belonging to opposing faces and centroid vertex C0 form a straight line. For example, the decoding device determines whether centroid vertex C0 exists on straight line L0 that passes through face vertex F0 and face vertex F2. A pair of face vertices (for example, F0 and F2) that satisfies this condition is called a pair of linear vertices. It should be noted that centroid vertex C0 existing on straight line L0 may mean, for example, that the distance between straight line L0 and centroid vertex C0 is less than a predetermined threshold value.

Furthermore, the decoding device determines whether a pair of linear vertices (for example, F1 and F3) also exists in other opposing faces. For example, the decoding device determines whether centroid vertex C0 exists on straight line L1 that passes through face vertex F1 and face vertex F3. Then, when two pairs of linear vertices exist, the decoding device determines that the original point cloud is a flat surface. In addition, in the example of FIG. 14, since a pair of linear vertices exists in the two faces facing each other in a z direction and the two faces facing each other in the x direction, it is determined that a flat surface of the original point cloud exists in an xz plane. In addition, a condition in which two pairs of linear vertices exist in a current node as described above is called a 2-straight-line-in-a-node condition.

Here, the case where a face vertex exists on a straight line connecting centroid vertices of neighboring nodes means that the original point cloud has existed on the straight line.

In addition, as another method of determining a pair of linear vertices, it may be determined whether two vectors from centroid vertex C0 to respective face vertices (for example, F0 and F2) of two opposing surfaces have the same direction. Here, the two vectors having the same direction may be a case where the difference in the directions of the vectors is 0 degree or 180 degrees, or falls within a certain range from these criteria. It should be noted that, here, although the example of using the vectors will be described, directions may be used instead of vectors. In addition, also in the following description, directions may be similarly used instead of vectors.

For example, the decoding device may use the following method as a method of obtaining a flat surface by using an equation. The decoding device calculates the cross product of a line segment connecting a pair of face vertices that face each other in a node, and a line segment connecting a pair of other face vertices that face each other. Next, the decoding device obtains a flat surface whose normal direction is equal to the calculated cross product as a flat surface that includes face vertices and a centroid vertex.

In addition, for a node that is determined to have a flat surface, the decoding device adjusts the position of an edge vertex from the positions of the face vertices and the centroid vertex. Accordingly, the accuracy of the position of an edge vertex can be increased, and a flat surface can be reconstructed from this group of vertices.

In addition, for a node that is not determined to have a flat surface, the decoding device performs normal surface reconstruction processing, without adjusting the position of an edge vertex.

For example, as illustrated in FIG. 14, edge vertex E0 is adjusted to edge vertex E4. Specifically, the decoding device may move the edge vertex (E0) on an edge of a node to the intersecting position (the position of E4) of the estimated flat surface and the edge.

Alternatively, the decoding device may move the edge vertex (E0) on an edge to the intersecting position (the position of E4) of a straight line (L2 in FIG. 14) connecting two face vertices that belong to a continuous surface between neighboring nodes, and the edge.

It should be noted that although FIG. 14 illustrates the example in which only edge vertex E0 is adjusted, edge vertices E1, E2, and E3 are also adjusted similarly to edge vertex E0.

FIG. 15 is a diagram for describing another adjusting method of edge vertices. FIG. 15 illustrates an example in which node 2 is a current node, and edge vertex E0 is to be adjusted. It should be noted that other edge vertices included in node 2 may also be adjusted similar to edge vertex E0.

First, the decoding device calculates, for edge vertex E0, offset amounts OS1 and OS2 that are individual amounts of movement seen from centroid vertex C0 to two face vertices F1 and F2 generated in two surfaces sharing the edge to which edge vertex E0 belongs. Next, the decoding device adjusts the position of edge vertex E0 to the position (the position of E1) obtained by adding these offset amounts OS1 and OS2 to the position of centroid vertex C0.

It should be noted that, here, the example has been described in which, when a node is determined to have a flat surface, an erroneously generated edge vertex is adjusted, but when a node is determined to have a flat surface, the decoding device may exclude an edge vertex that exists on an edge intersecting with (orthogonal to) the flat surface from vertices to be used for flat surface reconstruction.

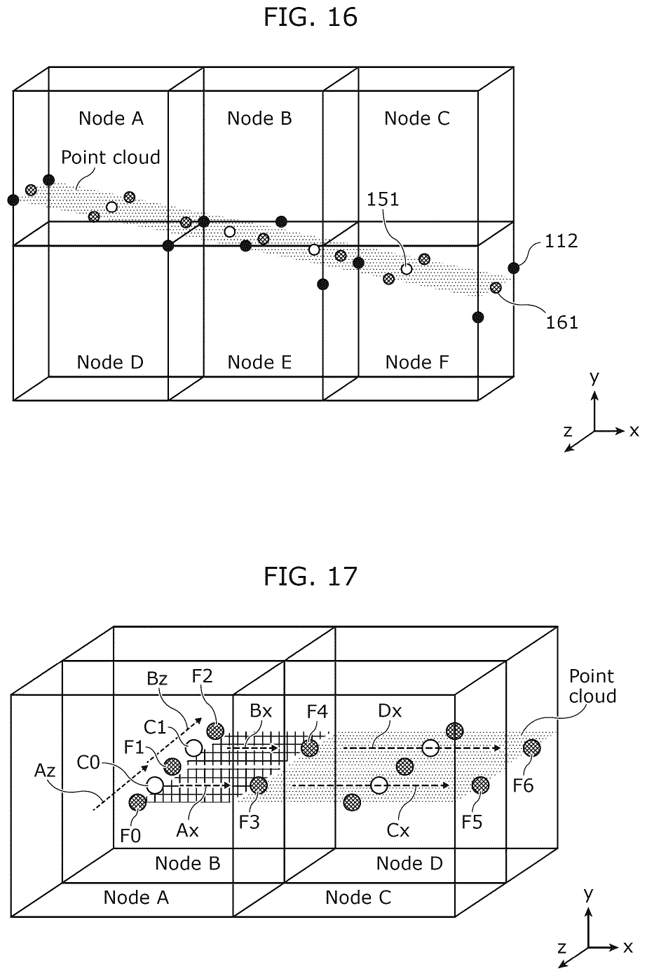

FIG. 16 is a diagram illustrating an example of a plurality of vertices in a case where an inclined surface intersects with a group of nodes in a three-dimensional manner. Also in this case, the inclined surface can be reconstructed with the above-described technique. Specifically, centroid vertex 151 and face vertex 161 are generated in each of node B and node E illustrated in FIG. 16. Even in this case, since centroid vertex 151 and face vertex 161 are linearly arranged, determination of a flat surface can be individually executed in each node.

With the above method, the decoding device determines whether a current node has a flat surface, and adjusts an edge vertex when the current node has a flat surface. Accordingly, since a flat surface can be correctly reconstructed, the accuracy of a point cloud to be reconstructed can be improved. In addition, in the above-described method, it is possible to realize the determination of whether a current node has a flat surface and the adjustment of an edge vertex, only by using the information in the current node (without using the information of a neighboring node).

It should be noted that, as the method of determining whether or not the original point cloud is to be reconstructed on a flat surface spanning a neighboring node, methods other than the above-described method may be used. For example, the decoding device may perform the determination by using a first centroid vertex of a first node adjacent to a current node in a first direction, a second centroid vertex of a second node adjacent to the current node in a second direction orthogonal to the first direction, a first face vertex generated in a surface of the current node adjacent to the first node, and a second face vertex generated in a surface of the current node adjacent to the second node. For example, the decoding device may determine that the current node has a flat surface, when these four vertices are included in the same flat surface.

Although the example of determining the case where a flat surface crossing a node exists has been described above, a method of determining whether a flat surface that is interrupted within a node exists will be described below. With this method, since the area of a flat surface that can be correctly reconstructed is more increased, the quality of a point cloud to be reconstructed can be improved.

FIG. 17 is a diagram illustrating an example of vertices generated in four nodes A to D. In the example illustrated in FIG. 17, in node C and node D, a flat surface (point cloud) crossing these nodes exists, and in node A and node B, a flat surface (point cloud) exists in a right half (in an x-axis positive direction) of these nodes.

In this case, for example, although a pair of face vertices (F0 and F1) exist on opposing surfaces in node A, two pairs of linear vertices do not exist. It should be noted that a condition in which one pair of linear vertices exist in a current node is called a 1 straight-line-in-a-node condition. Similarly, although a pair of face vertices (F1 and F2) exist on opposing surfaces in node B, two pairs of linear vertices do not exist. Thus, node A and node B do not meet the aforementioned 2-straight-line-in-a-node condition.

In this case, there is a possibility that a half surface in the x-axis positive direction in node A and node B is a continuation of a flat surface continuing from the right side. In order to determine such a flat surface having a half surface in a node, the decoding device performs the following determination.

When a current node satisfies the 1-straight-line-in-a-node condition, and a 1-straight-line-outside-a-node condition is satisfied in other direction (the x-axis positive direction in the example of FIG. 17) orthogonal to the direction (the z direction in the example of FIG. 17) that satisfies the 1-straight-line-in-a-node condition, the decoding device determines that a flat surface exists in a half surface in the other direction (the x-axis positive direction side). Here, the 1-straight-line-outside-a-node condition is that the direction of straight line Ax formed by centroid vertex C0 and face vertex F3 in node A and the direction of straight line Cx formed by a pair of linear vertices (F3 and F5) in neighboring node C in a direction Ax are the same, or have the difference less than a predetermined value.

Also in node B, since a current node satisfies the 1-straight-line-in-a-node condition, and the 1-straight-line-outside-a-node condition is satisfied in the other direction (the x-axis positive direction in the example of FIG. 17) orthogonal to the direction (the z direction in the example of FIG. 17) that satisfies the 1-straight-line-in-a-node condition, it is determined that a flat surface exists in a half surface in the other direction (x-axis positive direction). Specifically, in node B, since the direction of straight line Bx formed by centroid vertex C1 and face vertex F4 and the direction of straight line Dx formed by a pair of linear vertices (F4 and F6) in neighboring node D in a direction Bx are the same, or have the difference less than the predetermined value, it is determined that the flat surface exists in the half surface on the x-axis positive direction side in node B.

The decoding device adjusts the positions of edge vertices on edges that intersect with the region of a half surface as in the above-described processing of the flat surface, so as to reproduce a surface in the current node. It should be noted that an edge vertex is not illustrated in FIG. 17.

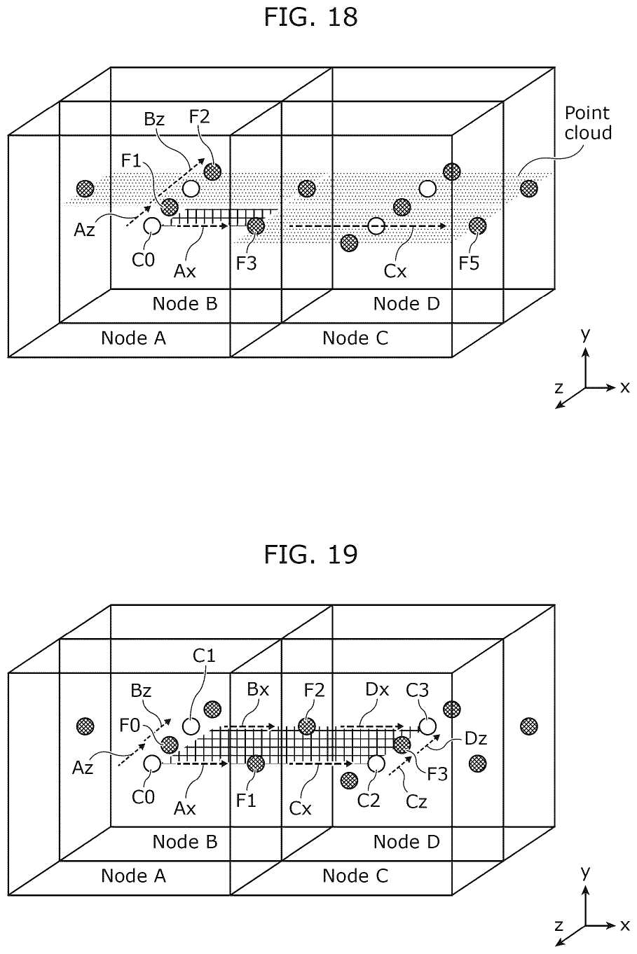

FIG. 18 is a diagram illustrating an example of vertices generated in four nodes A to D. In the example illustrated in FIG. 18, in node B, node C, and node D, a flat surface (point cloud) crossing these nodes exists, and in node A, a flat surface (point cloud) exists in a ¼ surface on a right back side (a z-axis negative direction and the x-axis positive direction) of the node.

In this example, node A does not satisfy the 2-straight-line-in-a-node condition and the 1-straight-line-in-a-node condition. In this case, the decoding device determines whether or not the above-described 1-straight-line-outside-a-node condition is satisfied in two directions. It should be noted that a condition in which the 1-straight-line-outside-a-node condition is satisfied in two directions is called a 2-straight-line-outside-a-node condition.

In the example of FIG. 18, face vertex F1 exists in a border surface between node A and node B adjacent to node A in the z-axis negative direction, and node B has a pair of vertices (F1 and F2) on a straight line, and the direction of straight line Az formed by centroid vertex C0 and face vertex F1 in node A and the direction of straight line Bz formed by the pair of linear vertices (F1 and F2) in neighboring node B are the same, or have the difference less than the predetermined value.

In addition, face vertex F3 exists in a border surface between node A and node C adjacent to node A in the x-axis positive direction, and node C has a pair of vertices (F3 and F5) on a straight line in the same direction (x-axis direction), and the direction of straight line Ax formed by centroid vertex C0 and face vertex F3 in node A and the direction of straight line Cx formed by the pair of linear vertices (F3 and F5) in neighboring node C are the same, or have the difference less than the predetermined value.

In this case, the decoding device estimates that a ¼ region in the x-axis positive direction and the z-axis negative direction in node A is a flat surface region that continues from the neighboring nodes. In this manner, in each of the neighboring nodes in the two directions, when a pair of vertices on a straight line exist in the direction from the current node to the neighboring node, the decoding device estimates that the ¼ region of the current node is a similar flat surface. In addition, the decoding device adjusts the positions of edge vertices generated on edges that intersect with the flat surface, so as to reproduce a surface in the current node. It should be noted that an edge vertex is not illustrated in FIG. 18.

FIG. 19 is a diagram illustrating an example of vertices generated in four nodes A to D. In the example illustrated in FIG. 19, a flat surface (point cloud) exists in a ¼ surface in node A to node D. Specifically, the ¼ flat surface exists in the z-axis negative direction and the x-axis positive direction in node A, in a z-axis positive direction and the x-axis positive direction in node B, in the z-axis negative direction and the x-axis negative direction in node C, and in the z-axis positive direction and the x-axis negative direction in node D.

As illustrated in FIG. 19, even in a case where a node determined to have a flat surface does not exist in the above-described determination, when a face vertex is generated in the border surface between each of the neighboring four nodes, the decoding device determines four ¼ surfaces in the respective nodes to be flat surfaces.

Specifically, (1) when the direction of straight line Az formed by centroid vertex C0 and face vertex F0 in the z-axis negative direction in node A and the direction of straight line Bz formed by centroid vertex C1 and face vertex F0 in the z-axis positive direction in node B are the same, or have the difference less than the predetermined value, and (2) when the direction of straight line Ax formed by centroid vertex C0 and face vertex F1 in the x-axis positive direction in node A and the direction of straight line Cx formed by centroid vertex C2 and face vertex F1 in the x-axis negative direction in node C are the same, or have the difference less than the predetermined value, and (3) when the direction of straight line Bx formed by centroid vertex C1 and face vertex F2 in the x-axis positive direction in node B and the direction of straight line Dx formed by centroid vertex C3 and face vertex F2 in the x-axis negative direction in node D are the same, or have the difference less than the predetermined value, and (4) when the direction of straight line Cz formed by centroid vertex C2 and face vertex F3 in the z-axis negative direction in node C and the direction of straight line Dz formed by centroid vertex C3 and face vertex F3 in the z-axis positive direction in node D are the same, or have the difference less than the predetermined value, the decoding device determines the ¼ flat surface exists in each of nodes A to D. It should be noted that the above-described conditions are called the collection of 2-straight-line-outside-a-node conditions.

In addition, the decoding device adjusts the positions of edge vertices generated on edges that intersect with the flat surface, so as to reproduce a surface in the current node. It should be noted that edge vertices are not illustrated in FIG. 19.

It should be noted that in the case where the decoding device determines that a flat surface exists in the half surface in the aforementioned node or in the ¼ surface in the node, when the flat surface continues to just before an end of a slice, even when a face vertex does not exist in a node in the end of the slice or in a slice cut surface, based on the continuity of a node that has the flat surface up to the node, the decoding device may determine the entire surface of the node to be a flat surface.

For example, in the example illustrated in FIG. 17, when a left surface (the surface in the x-axis negative direction) of node A is an end of a slice, the entire surface of node A may be determined to be a flat surface. In this case, the decoding device adjusts the positions of edge vertices generated on edges that intersect with the flat surface, so as to reproduce a surface in the current node.

Here, the information in the above-described node required for the flat surface reconstruction processing in the node is only a centroid vertex and a face vertex, and the coordinates of the reconstructed edge vertex itself is information unnecessary for the flat surface reconstruction processing. Therefore, for reduction of the transmission data amount, the encoding device may experimentally perform the above-described flat surface reconstruction processing once, and need not perform transmission of the information of an edge vertex for a node that meets a flat surface reconstruction condition. That is, the encoding device need not store, in a bitstream, the information of the edge vertex of the node that meets the flat surface reconstruction condition.

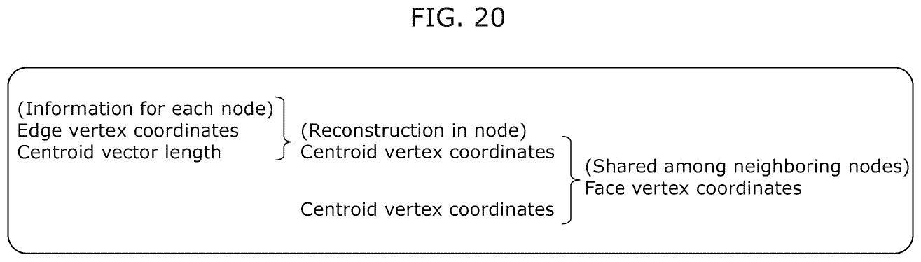

FIG. 20 is a diagram illustrating the dependency relationship of the information in reconstruction of vertex coordinates in a node in a TriSoup scheme. As illustrated in FIG. 20, the coordinates of an edge vertex and the centroid vector length are transmitted as the information for each node. Here, a centroid vector is a vector that extends in the normal direction of an approximate surface passing through a plurality of edge vertices, and extends from the approximate surface toward a centroid vertex. The decoding device calculates the coordinates of the centroid vertex for each node, by using these items of information. In addition, the decoding device calculates the coordinates of a face vertex from the coordinates of two centroid vertices of neighboring nodes.

Thus, for a node that does not transmit edge vertex coordinates, the dependency relationship for reconstructing vertices collapses, and it becomes impossible to reproduce the centroid vertex and the face vertex. In contrast, for a node that does not transmit the edge vertex coordinates, the encoding device does not transmit the centroid vector length, either. In addition, the encoding device adds, to a bitstream, an edge vertex no transmission flag indicating whether or not to transmit the edge vertex coordinates, and transmits the coordinates of the centroid vertex. Accordingly, the decoding device can reproduce the coordinates of the centroid vertex and the coordinates of the face vertex.

It should be noted that although the face vertex is used for the determination of a flat surface in the above-described description, the determination of a flat surface may be performed by connecting the centroid vertices of neighboring nodes, without using the face vertex.

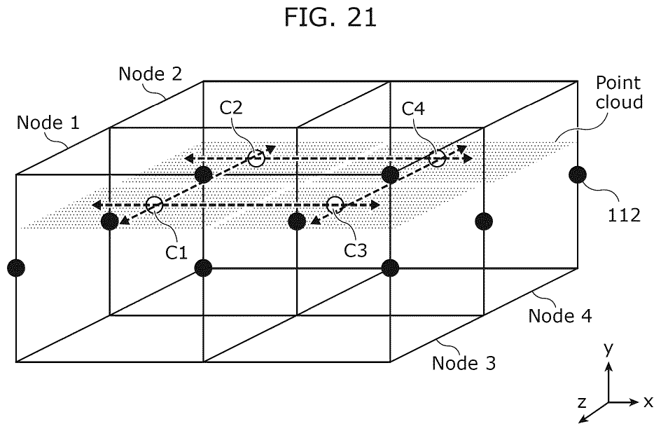

FIG. 21 is a diagram illustrating an example of the centroid vertices generated in four nodes 1 to 4 and edge vertices 112. In this case, the decoding device may determine that a flat surface exists when, for example, centroid vertices C1 to C4 of nodes 1 to 4 are included in the same flat surface. The decoding device adjusts the positions of edge vertices generated on edges that intersect with the flat surface, so as to reproduce a surface in the current node.

It should be noted that the following method may be used as the method of determining whether or not the original point cloud is to be reconstructed on the flat surface spanning a neighboring node. For example, when the first centroid vertex of the first node adjacent to the current node in the first direction and the centroid vertex of the current node are connected to each other, and the second centroid vertex of the second node adjacent to the current node in the second direction orthogonal to the first direction and the centroid vertex of the current node are connected to each other, the decoding device may determine that the current node has a flat surface. For example, the information indicating whether or not the first centroid vertex and the centroid vertex of the current node are connected to each other, and the information indicating whether or not the second centroid vertex and the centroid vertex of the current node are connected to each other are generated by the encoding device and stored in a bitstream. The decoding device uses these items of information to perform the above-described determination.

### [Syntax Example]

A description will be given of a syntax example of the information included in a bitstream for realizing the above-described technique.

The bitstream may include a first flag that indicates whether or not to apply the above-described scheme. When the first flag is ON, that is, when the first flag indicates that the above-described scheme is to be applied, the decoding device may perform the flat surface reconstruction processing to which the above-described scheme is applied.

The encoding device may store the first flag in, for example, an SPS (Sequence Parameter Set), a GPS (Geometry Parameter Set), a GDU (Geometry Data Unit), or a GDU header.

The SPS is metadata (a parameter set) common to a plurality of frames. The GPS is the metadata (a parameter set) related to encoding of geometry information. For example, the GPS is metadata common to a plurality of frames. The GDU is a data unit (geometry data unit) of encoded data of geometry information. The GDU header is the header (control information) of the GDU.

In addition, the first flag may be stored per node. That is, whether or not to apply the above-described scheme may be switched per node.

In addition, a parameter for switching between various methods or threshold values described in the scheme may be separately stored in a bitstream, in addition to the first flag. For example, the parameter may include the information for determining the tolerance range of the directions of two vectors at the time of determining the 2-straight-line-in-a-node condition. In addition, the parameter may include a second flag that indicates whether or not to perform the flat surface reconstruction in the above-described slice end.

These parameters may be stored in any of the SPS, the GPS, and GDU, or may be stored per node. Alternatively, the parameter may be stored in a bitstream when the first flag is ON, or may be always stored in a bitstream, irrespective of the value of the first flag.

### [Flowchart]

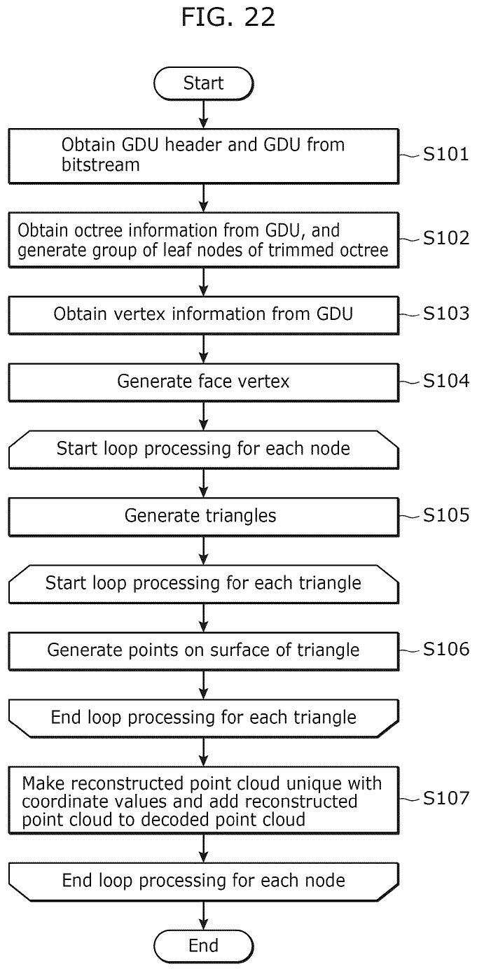

FIG. 22 is a flowchart of decoding processing by the decoding device. First, the decoding device obtains a GDU header and a GDU from a bitstream (S101). Next, the decoding device performs entropy decoding on octree information from the GDU, and generates a plurality of leaf nodes (a group of leaf nodes) of a trimmed octree by using the octree information (S102).

Next, the decoding device obtains, from the GDU, vertex information that indicates the positions of edge vertices and a centroid vertex (S103). Specifically, the decoding device obtains the vertex information by performing entropy decoding on the encoded vertex information included in the GDU.

Next, the decoding device generates a face vertex for each leaf node (hereinafter also simply written as a node) (S104). For example, in each node, the decoding device connects the centroid vertex of a current node and the centroid vertex of a neighboring node according to conditions, and generates a face vertex at the intersecting position of the obtained line segment and a node boundary.

Next, the decoding device performs the processing (loop processing) in the following steps S105 to S107 for each of the plurality of nodes of the trimmed octree. First, the decoding device connects a group of vertices (the plurality of edge vertices, the centroid vertex, and the face vertex) in the current node to generate a plurality of triangles (TriSoup surfaces) (S105).

Next, the decoding device performs the processing (loop processing) in the following step S106 for each of the plurality of triangles in the current node. The decoding device generates a plurality of points on a surface of a target triangle (S106). As a result of the above, the loop processing for each of the triangles ends.

Next, the decoding device adds the reconstructed point cloud in the current node to the decoded point cloud after making the reconstructed point cloud unique with coordinate values (S107). Here, making the point cloud unique means excluding points with duplicate coordinate values. As a result of the above, the loop processing for each node ends.

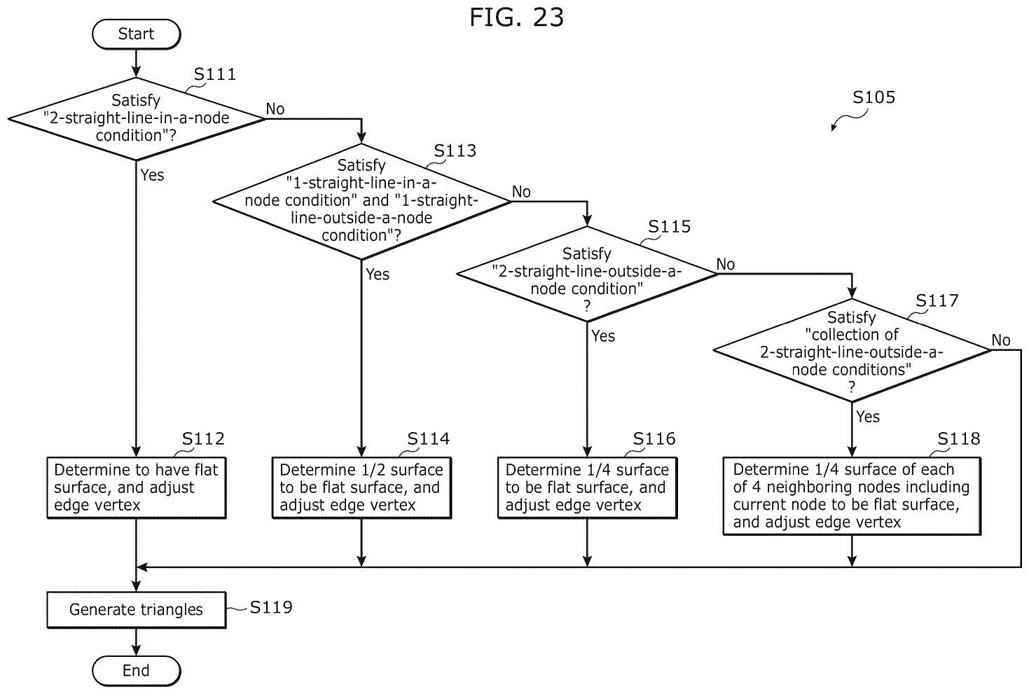

FIG. 23 is a flowchart of the generation processing of a plurality of triangles (S105). First, the decoding device determines whether or not the current node satisfies “the 2-straight-line-in-a-node condition” described above (S111). When the current node satisfies “the 2-straight-line-in-a-node condition” (Yes in S111), the decoding device determines that the current node has a flat surface, and adjusts the position of an edge vertex on an edge that intersects with the flat surface to, for example, a position on the flat surface (S112).

When the current node does not satisfy “the 2-straight-line-in-a-node condition” (No in S111), the decoding device determines whether or not the current node satisfies “the 1-straight-line-in-a-node condition” and “the 1-straight-line-outside-a-node condition” described above (S113). When the current node satisfies both “the 1-straight-line-in-a-node condition” and “the 1-straight-line-outside-a-node condition” (Yes in S113), the decoding device determines that a flat surface exists in a half surface of the current node, and adjusts the position of an edge vertex on an edge that intersects with the flat surface to, for example, a position on the flat surface (S114).

When the current node does not satisfy at least one of “the 1-straight-line-in-a-node condition” and “the 1-straight-line-outside-a-node condition” (No in S113), the decoding device determines whether or not the current node satisfies “the 2-straight-line-outside-a-node condition” described above (S115). When the current node satisfies “the 2-straight-line-outside-a-node condition” (Yes in S115), the decoding device determines that a flat surface exists in a ¼ surface of the current node, and adjusts the position of an edge vertex on an edge that intersects with the flat surface to, for example, a position on the flat surface (S116).

When the current node does not satisfy “the 2-straight-line-outside-a-node condition” (No in S115), the decoding device determines whether or not the current node satisfies “the collection of 2-straight-line-outside-a-node conditions” described above (S117). When the current node satisfies “the collection of 2-straight-line-outside-a-node conditions” (Yes in S117), the decoding device determines that a flat surface exists in a ¼ surface of each of four neighboring nodes including the current node, and adjusts the position of an edge vertex on an edge that intersects with the flat surface to, for example, a position on the flat surface (S118). It should be noted that the four neighboring nodes are, for example, a group of nodes in which each node is adjacent to the other two nodes in the same flat surface, as in node A to node D illustrated in FIG. 19.

After step S112, S114, S116 or S118, the decoding device generates a plurality of triangles by using a plurality of edge vertices including the adjusted edge vertices, the centroid vertex, and a plurality of face vertices (S119).

On the other hand, when the current node does not satisfy “the collection of 2-straight-line-outside-a-node conditions” (No in S117), the decoding device does not perform adjustment of an edge vertex, and generates a plurality of triangles by using the centroid vertex, the plurality of edge vertices, and the plurality of face vertices (S119).

It should be noted that not all of the determinations illustrated in FIG. 23 need to be necessarily performed, and only a part of the determinations may be performed. An order of determination is an example, determination may be performed in a different order, and determination may be performed in parallel.

### Embodiment 2

### [Problem of Flat Surface Reconstruction]

Using the above various vertices to reconstruct a point cloud having a flat surface may fail to create a flat surface on the reconstructed point cloud and may create a surface with unevenness that does not exist in the original point cloud. Possible causes of this are as follows, in addition to the cause described in Embodiment 1 above. It is to be noted that this problem arises regardless of whether the reconstruction uses a surface that spans neighboring nodes through face vertices.

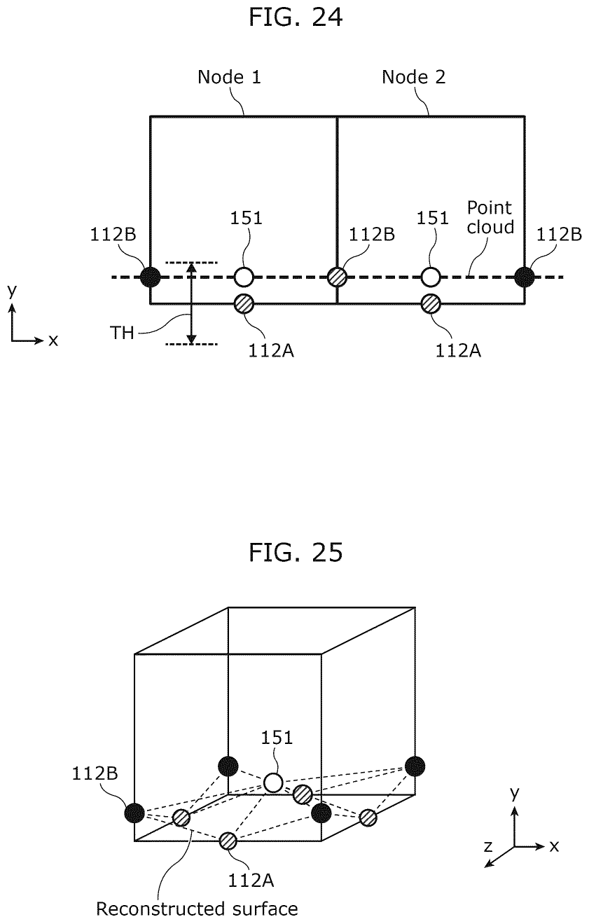

One possible cause is a sensitivity issue in the edge vertex generation processing. FIG. 24 is a diagram for describing this problem, illustrating an example of generating edge vertices 112A and 112B and centroid vertices 151. FIG. 24 shows nodes 1 and 2 arranged in the x-direction.

For points in the original point cloud distributed near an edge, an edge vertex is generated when the sum of the index values of these points, weighted according to their distances to the edge, exceeds a threshold TH. When the surface of the point cloud is distributed close to a node boundary surface, points around edge vertices 112A on the edges parallel to the point cloud are more heavily weighted than points around desired edge vertices 112B on the edges orthogonal to the point cloud. Thus, edge vertices 112A are erroneously generated on the edges parallel to the point cloud.

FIG. 25 is a diagram illustrating an example of a surface to be reconstructed (reconstructed surface) with erroneously generated edge vertices 112A. As shown in FIG. 25, surface reconstruction with these erroneously generated edge vertices 112A creates a distorted surface.

Furthermore, when the original point cloud is sparse, edge vertices 112B that should be generated may fail to be generated. All these causes prevent the decoding device from reconstructing a high-quality point cloud from a vertex group obtained from data transmitted according to the TriSoup scheme.

### [Solution]

The above problem can be solved by the following methods. It is to be noted that the following processing can be performed in one or both of the encoding device and the decoding device. In both the encoding device and the decoding device, when edge vertices are generated on all the four edges belonging to the same surface of a leaf node, the edge vertices can be determined to be erroneously generated vertices. Therefore, the encoding device and the decoding device may perform solution processing when four edge vertices disposed on the same surface are detected.

### [First Method]

Now, a first method for solving the above problem will be described. It is to be noted that the first method is performed in the encoding device. FIG. 26 is a diagram illustrating an example of generating centroid vertex 151 and edge vertices 112A and 112B. In FIG. 26, in addition to three correct edge vertices 112B, four edge vertices 112A are erroneously generated on the bottom surface. Furthermore, an edge vertex that should be generated in region 201 is not generated.

First, the encoding device determines whether the current node has a four-vertex surface, which is a surface with four edge vertices disposed thereon. When the current node has a four-vertex surface, the encoding device determines that the current node includes erroneously generated vertices, which are edge vertices that have been erroneously generated, and re-generates edge vertices of the current node.

At this point, the encoding device may re-generate edge vertices by excluding the four edges belonging to the four-vertex surface (the bottom surface in FIG. 26) from the target edges for edge vertex generation. Furthermore, when the initial edge vertex generation has failed to generate edge vertices on all the four edges orthogonal to the four-vertex surface, the encoding device may relax the threshold TH used for edge vertex generation and then re-generate edge vertices.

It is to be noted that, when the point cloud being reconstructed is distributed to coincide with a surface of the node, edge vertices based on the point cloud are generated at the bottom of the orthogonal edges orthogonal to the four-vertex surface. Therefore, the edge vertices erroneously generated on the four-vertex surface can be deleted without any problem.

For example, the encoding device uses a default value of 2 (in coordinate grid square) as the threshold for the distance between edges and points, and relaxes the threshold by incrementing it by one grid square for every re-generation. Furthermore, the threshold may have the upper limit. This can prevent setting a threshold greater than the node width. It is to be noted that the default value may be any value.

For example, the default value of the threshold may be 1, and the upper limit may be approximately 50% of the node width. Alternatively, the default value may be greater than 1, and the upper limit may be less than 25% of the node width.

This threshold adjustment may be applied to only the four edges orthogonal to the four-vertex surface, to all the eight edges remaining after excluding the four edges of the four-vertex surface, or threshold may be varied for each individual edge according to other conditions.

This threshold relaxation and vertex generation processing may be repeated iteratively until the correct edge vertices are generated on all the four orthogonal edges.

Alternatively, the vertex re-generation may involve only relaxing the threshold without excluding the edges of the four-vertex surface from the target edges. Furthermore, when, for example, the point cloud is distributed very close to the four-vertex surface, the centroid vertex still maintains its height. Therefore, using another flat surface reconstruction technique (e.g., the technique described in Embodiment 1), face vertices can be generated at the correct height to reconstruct a flat surface. Thus, the processing in this embodiment may be used as preprocessing for the edge vertex correction processing described in Embodiment 1. That is, the edge vertex group re-generated by the processing in this embodiment and the centroid vertex may be used to reconstruct a flat surface based on the technique in Embodiment 1. It is to be noted that the processing in Embodiment 1 need not be performed.

The above processing enables the decoding device to reconstruct an accurate geometric shape. In addition, the above processing can eliminate unnecessary edge vertex data in the transmitted data and simplify processing in the decoding device.

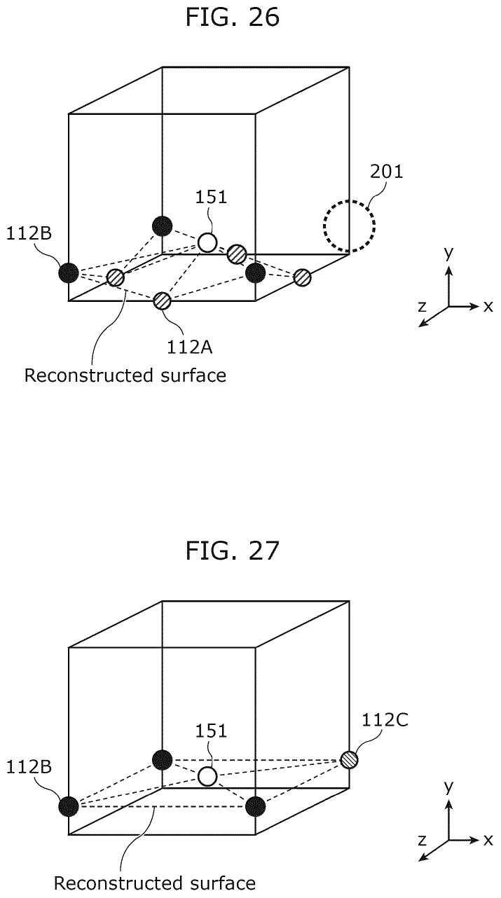

FIG. 27 is a diagram illustrating an example of a surface to be reconstructed by the above processing. Edge vertices 112A generated on the four-vertex surface shown in FIG. 26 are excluded. Furthermore, correct edge vertex 112C is added by the edge vertex re-generation with the threshold varied. Thus, a flat surface is reconstructed.

It is to be noted that the encoding device stores, in the bitstream, information indicating the positions of the edge vertices re-generated as above. The decoding device can use this information for edge vertex generation to generate the correct edge vertices.

### [Second Method]

Now, a second method for solving the above problem will be described. It is to be noted that the second method is performed in the encoding device or the decoding device. It is noted that although the following describes an example of processing performed in the encoding device, similar processing may be performed in the decoding device.

The second method differs from the first method in the manner of edge vertex re-generation. In the edge vertex re-generation, the encoding device excludes the four edge vertices belonging to the four-vertex surface (the bottom surface in FIG. 26). Furthermore, when not all the four orthogonal edges orthogonal to the four-vertex surface have edge vertices generated thereon, the encoding device generates an edge vertex on each orthogonal edge having no edge vertex generated thereon. For example, as shown in FIG. 26, edge vertices 112B are generated on three of the four orthogonal edges, and no edge vertex is generated on the remaining one edge. The encoding device then generates edge vertex 112C at the height estimated from the three edge vertices 112B, as shown in FIG. 27.

For example, when the point cloud is a flat surface intersecting the node in parallel to a node surface, the heights of the edge vertices generated should be close to each other. Therefore, the height of the fourth edge vertex can be determined from the average of the heights of the three edge vertices. Thus, the encoding device may supplementarily generate the fourth edge vertex by estimating its height from the heights of the three edge vertices.

Similarly, when edge vertices are generated on two orthogonal edges and no edge vertices are generated on the remaining two orthogonal edges, or when an edge vertex is generated on one orthogonal edge and no edge vertices are generated on the remaining three orthogonal edges, the encoding device may generate an edge vertex on each orthogonal edge having no edge vertex generated thereon. For example, as in the above case, the height or average height of the one or two generated edge vertices may be used as the height of the remaining edge vertices.

Using the edge vertices generated by this method and the centroid vertex, face vertices can be generated at the correct height to reconstruct a flat surface through the edge vertex correction processing described in Embodiment 1. Thus, the processing in this embodiment may be used as preprocessing for the edge vertex correction processing described in Embodiment 1. That is, the edge vertex group re-generated by the processing in this embodiment and the centroid vertex may be used to reconstruct a flat surface based on the technique in Embodiment 1. It is to be noted that the processing in Embodiment 1 need not be performed.

Furthermore, when this second method is performed by the encoding device, the method enables reconstructing an accurate geometric shape as in the first method. In addition, the method can eliminate unnecessary edge vertex data in the transmitted data and simplify processing in the decoding device. Furthermore, the method can eliminate the need for vertex re-generation processing in the encoding device, thus reducing the processing amount in the encoding device.

Furthermore, when this second method is performed by the decoding device, the encoding device stores, in the bitstream, information indicating the positions of the edge vertices re-generated as above. The decoding device can use this information for edge vertex generation to generate the correct edge vertices. This enables the decoding device to reconstruct a geometric shape close to the original point cloud.

In this case, the decoding device may supplementarily generate the attribute information (such as color) of the added edge vertices, or the attribute information of the reconstructed point cloud. For example, based on the positions of points in the reconstructed point cloud, the decoding device may supplementarily generate the attribute information of the reconstructed point cloud using the attribute information of vertices or surrounding points. Alternatively, based on the positions of the added edge vertices, the decoding device may supplementarily generate the attribute information of the added edge vertices using the attribute information of other edge vertices. It is to be noted that this supplementation of the attribute information of the edge vertices or points may be performed by the encoding device. In that case, the encoding device stores, in the bitstream, the attribute information of three-dimensional points, including the supplementary attribute information.

### [Third Method]

Now, a third method for solving the above problem will be described. It is to be noted that the third method is performed in the encoding device or the decoding device. It is noted that although the following describes an example of processing performed in the encoding device, similar processing may be performed in the In the above-described determination of erroneously generated vertices (the first method) or estimation of missing vertex positions (the second method), estimation is easy when the original point cloud is a flat surface parallel to a node surface. However, estimation is not easy when the original point cloud is an inclined surface inclined relative to a node surface. In the third method, the arrangement directions of the centroid vertex and face vertices are utilized to determine erroneously generated vertices.

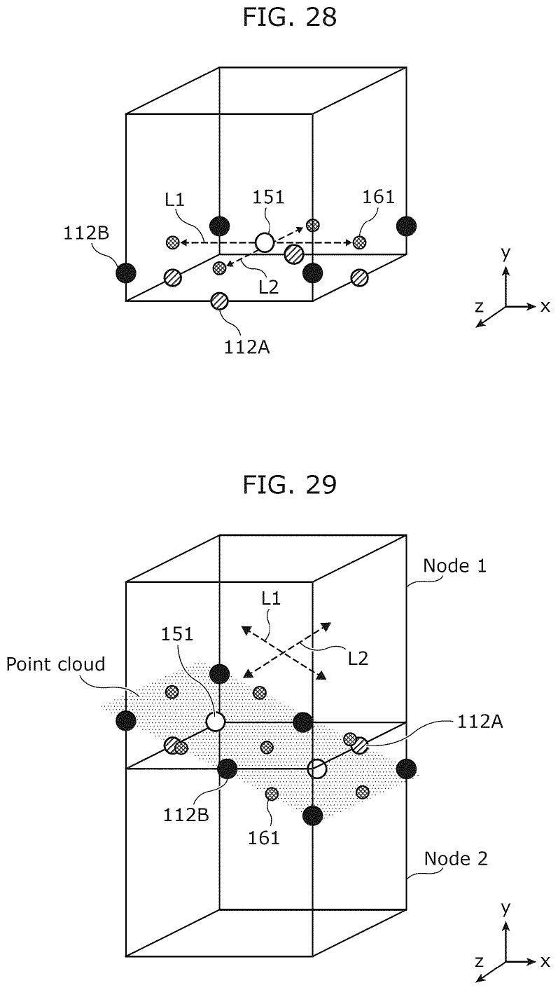

FIGS. 28 and 29 are diagrams for describing the third method, illustrating examples of generating centroid vertex 151, edge vertices 112A and 112B, and face vertices 161.

Centroid vertex 151 and face vertices 161 are all generated based on the distribution of the original point cloud. Therefore, the encoding device determines that edge vertices are erroneously generated vertices if they are on a node surface parallel to the plane that includes the two line segments (line segments L1 and L2 in the example shown in FIG. 28) formed by two pairs of face vertices 161 on opposed surfaces of the node.

For example, in an example shown in FIG. 28, the plane that includes line segments L1 and L2 is parallel to the bottom surface of the node. Therefore, four edge vertices 112A generated on the bottom surface are determined to be erroneously generated vertices and are deleted. Edge vertices are then re-generated using, for example, the above-described first or second method.

In contrast, in another example shown in FIG. 29, the plane that includes line segments L1 and L2 is not parallel to the bottom surface of node 1 (the top surface of node 2). Therefore, the four edge vertices generated on the bottom surface (two edge vertices 112A and two edge vertices 112B) are determined to include correct vertices, rather than erroneously generated vertices.

It is to be noted that, for the node surface determined to include correct vertices, the vertex positions can be used directly to perform edge vertex supplementation and flat surface reconstruction through the edge vertex correction processing in Embodiment 1. That is, edge vertex re-generation using the above-described first or second method is not performed.

It is to be noted that an inclined plane refers to a plane with an angular difference greater than or equal to a threshold between the normal of each surface of the node and the normal of the inclined plane formed by the original point cloud. The threshold may be, for example and without limitation, 10 degrees or 20 degrees. The threshold may be set as appropriate for each case.

In contrast, when the plane formed by the point cloud is parallel to any surface of the node, it means that the angular difference between their normals is smaller than a threshold. The threshold may be, for example and without limitation, 10 degrees or 20 degrees.

When this third method is performed by the encoding device, the encoding device stores, in the bitstream, information indicating the positions of the edge vertices re-generated as above. The decoding device can use this information for edge vertex generation to generate the correct edge vertices. This enables the decoding device to reconstruct an accurate geometric shape. In addition, the method can eliminate unnecessary edge vertex data in the transmitted data and simplify processing in the decoding device. Furthermore, the method may be able to eliminate the need for edge vertex re-generation processing in the encoding device, thus reducing the processing amount in the encoding device.

Alternatively, when this third method is performed by the decoding device, the decoding device decodes data resulting from encoding the edge vertices including erroneously generated edge vertices, and performs the above third method using the edge vertices obtained. This enables the decoding device to reconstruct a geometric shape close to the original point cloud.

In this case, the decoding device may supplementarily generate the attribute information (such as color) of the added edge vertices, or the attribute information of the reconstructed point cloud. For example, based on the positions of points in the reconstructed point cloud, the decoding device may supplementarily generate the attribute information of the reconstructed point cloud using the attribute information of vertices or surrounding points. Alternatively, based on the positions of the added edge vertices, the decoding device may supplementarily generate the attribute information of the added edge vertices using the attribute information of other edge vertices. It is to be noted that this supplementation of the attribute information of the edge vertices or points may be performed by the encoding device. In that case, the encoding device stores, in the bitstream, the attribute information of three-dimensional points, including the supplementary attribute information.

### [Example of Syntax]

The following will describe an example of the syntax of information, included in the bitstream, for implementing the above techniques.

The bitstream may include flags indicating whether the above methods are applied. For example, the bitstream may include a first flag indicating whether the decoding device is to apply the above second method. That is, when the first flag indicates that the above second method is applied, the decoding device may perform flat surface reconstruction processing using the second method. As another example, the bitstream may include a second flag indicating whether the decoding device is to apply the above third method. That is, when the second flag indicates that the above third method is applied, the decoding device may perform flat surface reconstruction processing using the third method.

Furthermore, the bitstream may include a third flag indicating whether the decoding device is to apply the above supplementation of attribute information. That is, when the third flag indicates that the above supplementation is applied, the decoding device may perform the above supplementation of attribute information.

The encoding device may store these flags in, for example, the SPS, GPS, or GDU. Furthermore, these flags may be stored on a node basis. It is to be noted that at least one of the first, second, and third flags may be stored in the bitstream. When multiple flags are stored, the flags may be stored at the same location or different locations.

Furthermore, the above flags may be implemented as a single flag collectively indicating the on or off status of the multiple types of processing, or as individual flags indicating the on or off statuses of the respective types of processing.

Furthermore, the above information may be transmitted regularly. In addition, the bitstream need not include the above information. In that case, the decoding device may still perform the above processing.

### [Flowcharts]

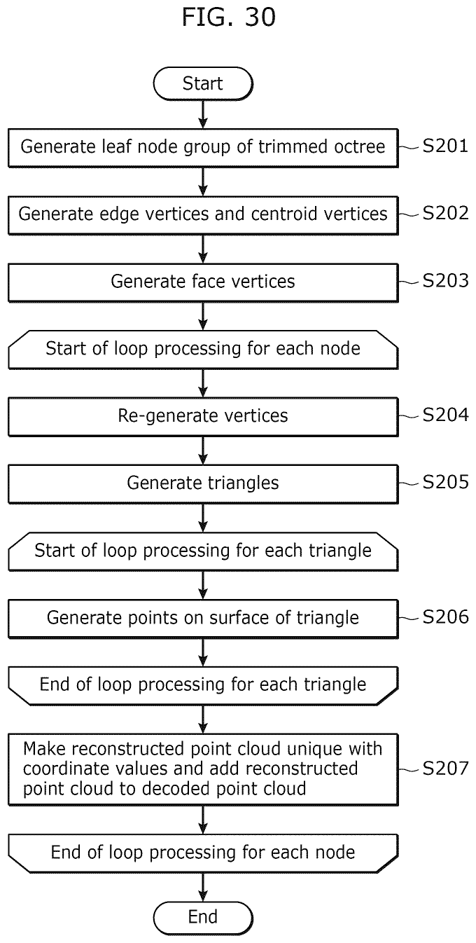

FIG. 30 is a flowchart of encoding processing performed by the encoding device. FIG. 30 illustrates processing in which the encoding device performs the above-described first and third methods.

First, the encoding device generates leaf nodes (a leaf node group) of a trimmed octree by dividing an original point cloud into an octree (S201). Next, the encoding device generates edge vertices and a centroid vertex of each leaf node (hereinafter also simply referred to as node) (S202).

Next, the encoding device generates face vertices of each node (S203). For example, the encoding device connects, for each node, the centroid vertex of current node and the centroid vertex of each of its neighboring nodes, according to conditions, and generates a face vertex at the intersection of the resulting line segment and the node boundary.

Next, the encoding device performs the following processing at steps S204 to S207 (loop processing) for each node of the trimmed octree. First, the encoding device determines whether the current node includes erroneously generated vertices, and if so, re-generates edge vertices (S204).

Next, the encoding device connects the vertex group (the edge vertices, the centroid vertex, and the face vertices) in the current node to generate triangles (a TriSoup surface) (S205). For example, the details of this processing are the same as those at S105 in FIG. 22 described in Embodiment 1.

Next, the encoding device performs the following processing at step S206 (loop processing) for each triangle in the current node. The encoding device generates points on the surface of the current triangle (S206). Thus, the loop processing for each triangle terminates.

Next, the encoding device adds the reconstructed point cloud in the current node to the decoded point cloud after making the reconstructed point cloud unique with coordinate values (S207). Here, making the point cloud unique means excluding points having duplicate coordinate values. Thus, the loop processing for each node terminates.

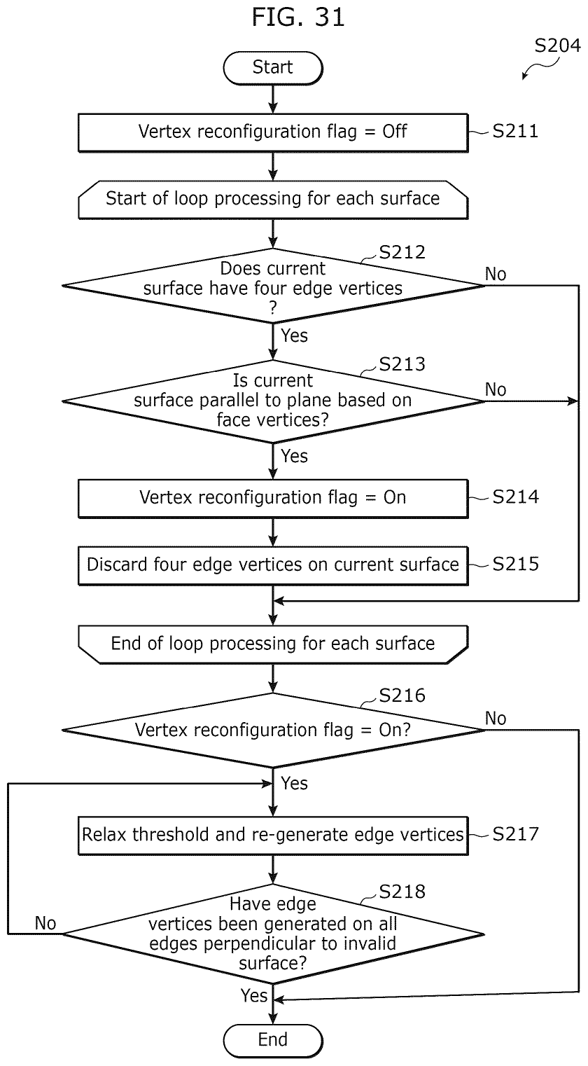

FIG. 31 is a flowchart of the edge vertex re-generation processing (S204). First, to initialize a vertex reconfiguration flag that indicates whether to reconfigure edge vertices, the encoding device sets the vertex reconfiguration flag off (S211).

Next, the encoding device performs the following processing at steps S212 to S215 (loop processing) for each surface of the current node. First, the encoding device determines whether the current surface has four edge vertices (S212). That is, the encoding device determines whether the four edges of the current surface each have an edge vertex generated thereon.

When the current surface has four edge vertices (Yes at S212), the encoding device determines whether the current surface is parallel to a plane that is based on the face vertices. Specifically, the encoding device determines whether the current surface is parallel to the plane defined by two pairs of opposed face vertices in the node (S213).

When the current surface is parallel to the above plane (Yes at S213), the encoding device determines the current surface to be an invalid surface that includes erroneously generated vertices, and sets the vertex reconfiguration flag on (S214). Next, the encoding device discards the four edge vertices on the current surface (the invalid surface) and excludes the four edges of the current surface (the invalid surface) from the target edges for edge vertex re-generation (S215). Thus, the loop processing for each surface of the current node terminates. When the current surface does not have four edge vertices (No at S212) or when the current surface is not parallel to the above plane (No at S213), the loop processing for each surface of the current node terminates.

Next, the encoding device determines whether the vertex reconfiguration flag for the current node is on (S216). When the vertex reconfiguration flag is on (Yes at S216), the encoding device relaxes a threshold used for edge vertex generation and re-generates edge vertices in the current node (S217).

Next, the encoding device determines whether edge vertices have been generated on all the four edges perpendicular to the invalid surface (S218). When edge vertices have not been generated on all the four edges (No at S218), the encoding device further relaxes the threshold used for edge vertex generation and re-generates edge vertices in the current node (S217).

When the vertex reconfiguration flag is off (No at S216) or when edge vertices have been generated on all the four edges (Yes at S218), the encoding device terminates the processing of step S204.

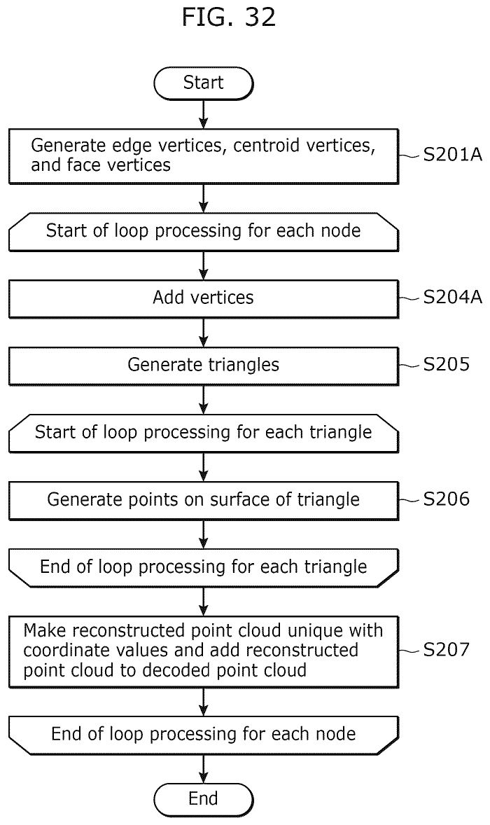

FIG. 32 is a flowchart of encoding processing in the encoding device and decoding processing in the decoding device for performing the above-described second and third methods. It is to be noted although the following describes processing performed in the encoding device, similar processing may be performed in the decoding device.

It is to be noted that the processing shown in FIG. 32 differs from the processing shown in FIG. 30 in that steps S201 to S203 are replaced by step S201A, and step S204 is replaced by step S204A.

First, the encoding device generates edge vertices, a centroid vertex, and face vertices of each leaf node (S201A). It is to be noted that the processing at step S201A in the encoding device is the same as the processing at steps S201 to S203 shown in FIG. 30, for example. Furthermore, the processing at step S201A in the decoding device is the same as the processing at steps S101 to S104 shown in FIG. 22, for example.

Next, the encoding device performs the following processing at steps S204A to S207 (loop processing) for each node of the trimmed octree. First, the encoding device adds edge vertices (S204A). Specifically, the encoding device determines whether the current node includes erroneously generated vertices, and if so, estimates the position of each missing edge vertex. It is to be noted that the processing at step S205 and the subsequent steps is the same as that in FIG. 30 and therefore will not be described.

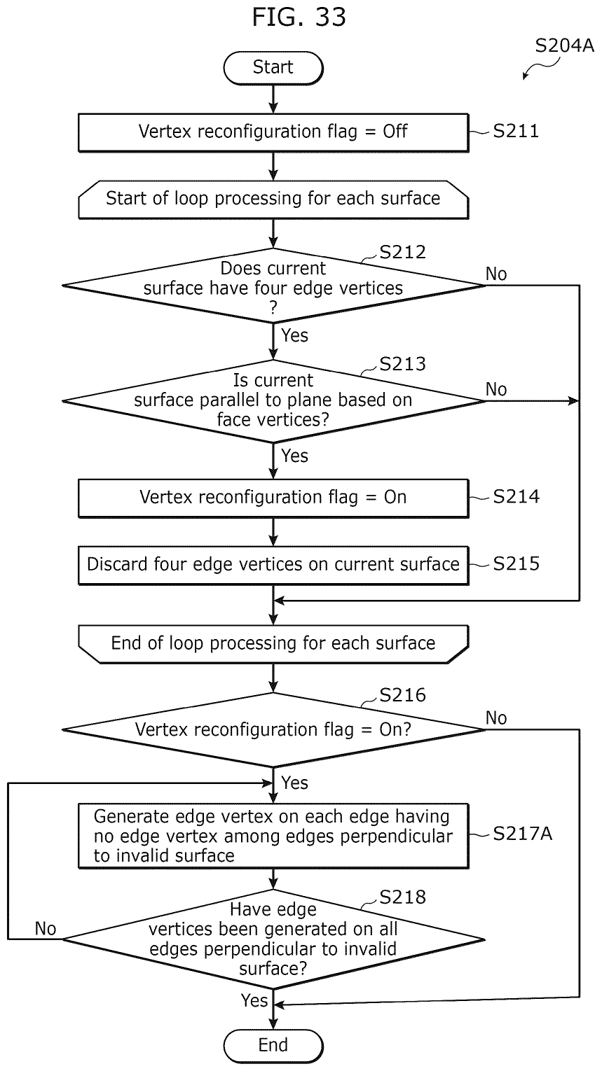

FIG. 33 is a flowchart of the processing of adding edge vertices (S204A). It is to be noted that the processing shown in FIG. 33 differs from the processing shown in FIG. 31 in that step S217 is replaced by step S217A. The following describes differences from FIG. 31.

When the vertex reconfiguration flag is on (Yes at S216), the encoding device generates an edge vertex on each edge having no edge vertex among the four edges perpendicular to the invalid surface (S217A). Specifically, the encoding device supplementarily adds the edge vertex using the positions of the edge vertices on the rest of the four edges perpendicular to the invalid surface.

### CONCLUSION

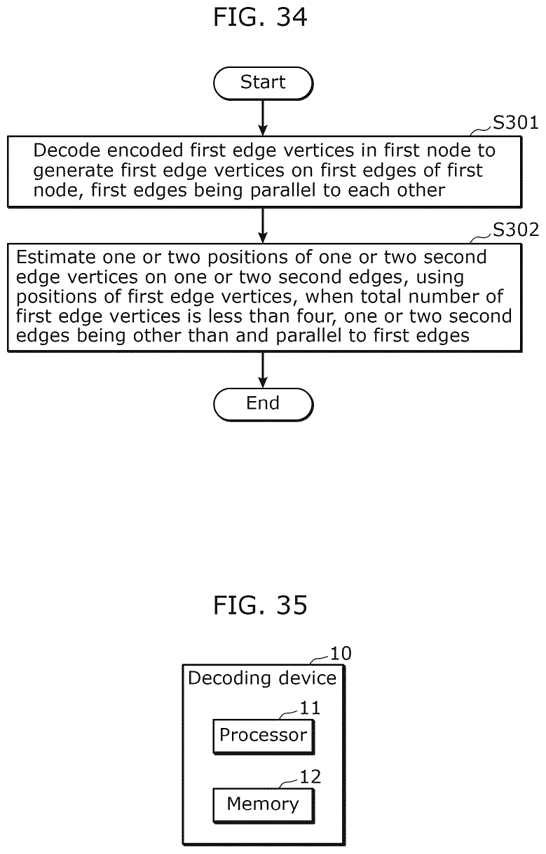

A decoding device (three-dimensional data decoding device) according to an embodiment performs the process illustrated in FIG. 34. The decoding device: decodes three-dimensional points. The decoding device decodes encoded first edge vertices in a first node to generate first edge vertices on first edges of the first node, the first edges being parallel to each other (S301); and estimates one or two positions of one or two second edge vertices on one or two second edges, using positions of the first edge vertices, when a total number of the first edge vertices is less than four, the one or two second edges being other than and parallel to the first edges (S302). The first edge vertices and the one or two second edge vertices are to be used in a TriSoup scheme. The first node is a unit for containing three-dimensional points included in an octree structure. For example, the decoding device decodes three-dimensional points using first edge vertices and one or two second edge vertices. For example, the decoding device generates a triangle using the first edge vertices and the one or two second edge vertices, and locates three-dimensional points on the triangle.

Accordingly, when an edge vertex is not correctly generated, the decoding device can additionally generate a second edge vertex. Accordingly, the decoding device can improve reproducibility of the point cloud to be decoded.

For example, the estimating (S302) is performed according to control information included in a bitstream and indicating whether to perform the estimating. Accordingly, the decoding device can determine whether to perform estimating, based on the control information generated by an encoding device, and thus the determining by a decoding device can be simplified, and the processing amount of the decoding device can be reduced.

For example, in the estimating, attribute information of the one or two second edge vertices is estimated from attribute information of the first edge vertices. Accordingly, the decoding device can improve reproducibility of the point cloud to be reduced, by estimating the attribute information of the second edge vertex.

For example, a decoding device decodes encoded three-dimensional points. The decoding device: determines whether a first surface of a first node is parallel to a cross section of the first node; and decodes the encoded three-dimensional points, based on a result of the determining. The first surface includes four edges on which four edge vertices are provided, respectively. The cross section (for example, a TriSoup triangle) passes through a centroid vertex in the first node. The cross section is defined by two pairs of face vertices, and the two pairs of face vertices are provided on second surfaces perpendicular to the first surface. A line connecting the first centroid vertex and a second centroid vertex of a second node adjacent to the first node intersects a face vertex included in the two pairs of face vertices. The first centroid vertex, the second centroid vertex, and the four edge vertices are to be used in a TriSoup scheme. The first node is a unit for containing three-dimensional points included in an octree structure. For example, the TriSoup triangle is a surface (approximate surface) that is included in the cross section of the first node and passes through the first centroid vertex.

Accordingly, the decoding device can, for example, determine whether a vertex is generated correctly, based on whether the first surface is parallel to the cross section of the first node, for example. Accordingly, the decoding device can improve reproducibility of the point cloud to be decoded, by performing decoding processing that is in accordance with the result of the determining, for example.

For example, when the first surface is determined not to be parallel to the cross section, the decoding device decodes the encoded three-dimensional points according to the TriSoup scheme to locate three-dimensional points on an approximate surface defined by the first centroid vertex and the four edge vertices. Accordingly, for example, when the first surface is not parallel to the cross section of the first node, the decoding device determines that the edge vertex is correctly generated, and generates an approximate surface using the edge vertex, thereby improving reproducibility of the point cloud to be decoded.

For example, when the first surface is determined to be parallel to the cross section, the decoding device decodes the encoded three-dimensional points to locate three-dimensional points on the cross section. Accordingly, for example, when the first surface is parallel to the cross section of the first node, the decoding device determines that the edge vertex is not correctly generated, and generates three-dimensional points in a cross section defined by a centroid vertex and a face vertex. Accordingly, reproducibility of the point cloud to be decoded can be improved.

FIG. 35 is a block diagram of decoding device 10. For example, decoding device 10 includes processor 11 and memory 12, and processor 11 performs the above-described processes using memory 12.

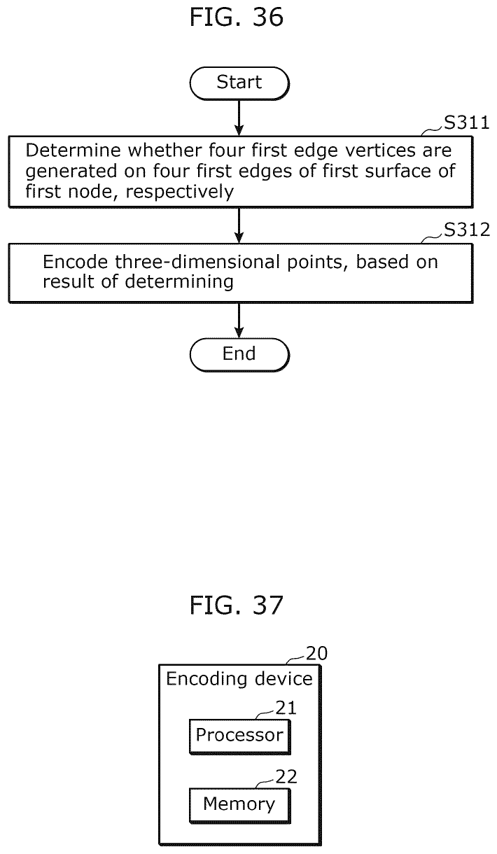

Furthermore, an encoding device (three-dimensional data encoding device) according to an embodiment performs the process illustrated in FIG. 36. The encoding device encodes three-dimensional points. The encoding device: determines whether four first edge vertices are generated on four first edges of a first surface of a first node, respectively (S311); and encodes the three-dimensional points, based on a result of the determining (S312). The four first edge vertices are to be used in a TriSoup scheme, and the first node is a unit for containing three-dimensional points included in an octree structure.

Accordingly, the encoding device can, for example, determine whether a first edge vertex is correctly generated, based on whether the four first edge vertices are generated on the four first edges of the first surface, respectively. Specifically, when first edge vertices are generated on all of the first edges, there is a possibility that an edge vertex for reconstructing an original point cloud is not correctly generated. Accordingly, the encoding device can, for example, improve reproducibility of the point cloud to be decoded by a decoding device, by performing encoding processing that is in accordance with the result of the determining. Encoding processing that is in accordance with the result of the determining refers to, for example, correcting an edge position or not generating an edge vertex to be described later.

For example, the encoding device further: performs at least one of a first process or a second process, when the four first edge vertices are generated on the four first edges, respectively. In the first process, second edge vertices are each generated on a different one of second edges of the first node, the second edges orthogonally intersecting the first surface, and, in the second process, a threshold for generating an edge vertex is increased, the threshold being a threshold to be compared to distances between three dimensional points and an edge. For example, an edge vertex is generated when there is a three-dimensional point whose distance to the edge is below the threshold.

Accordingly, when an edge vertex is not correctly generated, the encoding device can generate the correct edge vertex by generating an additional edge vertex or re-generating an edge vertex. Accordingly, reproducibility of the point cloud to be decoded by a decoding device can be improved.

For example, in the second process, the encoding device increases the threshold for the second edges. Accordingly, when an edge vertex is erroneously generated on the first surface and an edge vertex is not generated on some of the second edges, the encoding method can generate the correct edge vertices.

For example, in the second process, the encoding device repeatedly increases the threshold until the second edge vertices are generated. Accordingly, the encoding device can generate the appropriate edge vertex by gradually increasing the threshold.

For example, in the first process, when a total number of the second edge vertices is less than four, the encoding device estimates one or two positions of one or two edge vertices using positions of the second edge vertices. Accordingly, the encoding method can generate the edge vertex to be added, by using the second edge vertices.

For example, in the first process, when the total number is less than four, the encoding device estimates attribute information of the one or two edge vertices from attribute information of the second edge vertices. Accordingly, the encoding device can improve reproducibility of the point cloud to be decoded, by estimating the attribute information of the second edge vertices.

FIG. 37 is a block diagram of encoding device 20. For example, encoding device 20 includes processor 21 and memory 22, and processor 21 performs the above-described processes using memory 22.

An encoding device (three-dimensional data encoding device), a decoding device (three-dimensional data decoding device), and the like, according to embodiments of the present disclosure and variations thereof have been described above, but the present disclosure is not limited to these embodiments, etc.

Note that each of the processors included in the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as an encoding method (three-dimensional data encoding method), a decoding method (three-dimensional data decoding method), or the like executed by the encoding device (three-dimensional data encoding device), the decoding device (three-dimensional data decoding device), and the like.

Furthermore, the present disclosure may be implemented as a program for causing a computer, a processor, or a device to execute the above-described encoding method or decoding method. Furthermore, the present disclosure may be implemented as a bitstream generated by the above-described encoding method. Furthermore, the present disclosure as a recording medium on which the program or the bitstream is recorded. For example, the present disclosure may be implemented as a non-transitory computer-readable recording medium on which the program or the bitstream is recorded.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

An encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to an encoding device and a decoding device.

1. An encoding method for encoding three-dimensional points, the encoding method comprising:
determining whether four first edge vertices are generated on four first edges of a first surface of a first node, respectively; and
encoding the three-dimensional points, based on a result of the determining, wherein
the four first edge vertices are to be used in a TriSoup scheme, and
the first node is a unit for containing three-dimensional points included in an octree structure.

2. The encoding method according to claim 1, further comprising:
performing at least one of a first process or a second process, when the four first edge vertices are generated on the four first edges, respectively, wherein
in the first process, second edge vertices are each generated on a different one of second edges of the first node, the second edges orthogonally intersecting the first surface, and
in the second process, a threshold for generating an edge vertex is increased, the threshold being a threshold to be compared to distances between three dimensional points and an edge.

3. The encoding method according to claim 2, wherein
in the second process, the threshold for the second edges is increased.

4. The encoding method according to claim 2, wherein
in the second process, the threshold is repeatedly increased until the second edge vertices are generated.

5. The encoding method according to claim 2, wherein
in the first process, when a total number of the second edge vertices is less than four, one or two positions of one or two edge vertices are estimated using positions of the second edge vertices.

6. The encoding method according to claim 5, wherein
in the first process, when the total number is less than four, attribute information of the one or two edge vertices are estimated from attribute information of the second edge vertices.

7. A decoding method for decoding encoded three-dimensional points, the decoding method comprising:
decoding encoded first edge vertices in a first node to generate first edge vertices on first edges of the first node, the first edges being parallel to each other; and
estimating one or two positions of one or two second edge vertices on one or two second edges, using positions of the first edge vertices, when a total number of the first edge vertices is less than four, the one or two second edges being other than and parallel to the first edges, wherein
the first edge vertices and the one or two second edge vertices are to be used in a TriSoup scheme, and
the first node is a unit for containing three-dimensional points included in an octree structure.

8. The decoding method according to claim 7, wherein
the estimating is performed according to control information included in a bitstream and indicating whether to perform the estimating.

9. The decoding method according to claim 7, wherein
in the estimating, attribute information of the one or two second edge vertices are estimated from attribute information of the first edge vertices.

10. A decoding method for decoding encoded three-dimensional points, the decoding method comprising:
determining whether a first surface of a first node is parallel to a cross section of the first node; and
decoding the encoded three-dimensional points, based on a result of the determining, wherein
the first surface includes four edges on which four edge vertices are provided, respectively,
the cross section passes through a first centroid vertex of the first node,
the cross section is defined by two pairs of face vertices,
the two pairs of face vertices are provided on second surfaces perpendicular to the first surface,
a line connecting the first centroid vertex and a second centroid vertex of a second node adjacent to the first node intersects a face vertex included in the two pairs of face vertices,
the first centroid vertex, the second centroid vertex, and the four edge vertices are to be used in a TriSoup scheme, and
the first node is a unit for containing three-dimensional points included in an octree structure.

11. The decoding method according to claim 10, wherein
in the decoding, when the first surface is determined not to be parallel to the cross section, the encoded three-dimensional points are decoded according to the TriSoup scheme to locate three-dimensional points on an approximate surface defined by the first centroid vertex and the four edge vertices.

12. The decoding method according to claim 10, wherein
in the decoding, when the first surface is determined to be parallel to the cross section, the encoded three-dimensional points are decoded to locate three-dimensional points on the cross section.

13. An encoding device that encodes three-dimensional points, the encoding device comprising:
a processor; and
memory, wherein
using the memory, the processor:
determines whether four first edge vertices are generated on four first edges of a first surface of a first node, respectively; and
encodes the three-dimensional points, based on a result of the determining,
the four first edge vertices are to be used in a TriSoup scheme, and
the first node is a unit for containing three-dimensional points included in an octree structure.

14. A decoding device that decodes encoded three-dimensional points, the decoding device comprising:
a processor; and
memory, wherein
using the memory, the processor:
decodes encoded first edge vertices in a first node to generate first edge vertices on first edges of the first node, the first edges being parallel to each other; and
estimates one or two positions of one or two second edge vertices on one or two second edges, using positions of the first edge vertices, when a total number of the first edge vertices is less than four, the one or two second edges being other than and parallel to the first edges,
the first edge vertices and the one or two second edge vertices are to be used in a TriSoup scheme, and
the first node is a unit for containing three-dimensional points included in an octree structure.

15. A decoding device that decodes encoded three-dimensional points, the decoding device comprising:
a processor; and
memory, wherein
using the memory, the processor:
determines whether a first surface of a first node is parallel to a cross section of the first node; and
decodes the encoded three-dimensional points, based on a result of the determining,
the first surface includes four edges on which four edge vertices are provided, respectively,
the cross section passes through a first centroid vertex of the first node,
the cross section is defined by two pairs of face vertices,
the two pairs of face vertices are provided on second surfaces perpendicular to the first surface,
a line connecting the first centroid vertex and a second centroid vertex of a second node adjacent to the first node intersects a face vertex included in the two pairs of face vertices,
the first centroid vertex, the second centroid vertex, and the four edge vertices are to be used in a TriSoup scheme, and
the first node is a unit for containing three-dimensional points included in an octree structure.
